(19) United States
(12) Patent Application Publication
(10) Pub. No.: US 2026/0099499 A1
(43) Pub. Date: Apr. 9, 2026

(54) DEVICES, SYSTEMS, AND METHODS FOR CUSTOMIZING A USER EXPERIENCE BASED ON GEOSPATIAL DATA

(71) Applicant: Paul M. Herring, Mt. Pleasant, CA (US)

(72) Inventors: Paul M. Herring, Mt. Pleasant, SC (US); Josef Kirk Myers, II, Venice, CA (US); William Paul Herring, Mt. Pleasant, SC (US)

(73) Assignee: Paul M. Herring, Mt. Pleasant, CA (US)

(21) Appl. No.: 19/387,828

(22) Filed: Nov. 13, 2025

Related U.S. Application Data
(63) Continuation-in-part of application No. 18/910,635, filed on Oct. 9, 2024.

(51) Int. Cl. G06F 16/2457; G06F 3/0484; G06F 16/9537; G06K 7/10; G06K 7/14

(52) U.S. Cl. CPC G06F 16/24575; G06F 16/9537; G06K 7/10297; G06K 7/10366; G06K 7/1417; G06F 3/0484

(57) ABSTRACT

A computer-implemented method of customizing a user experience based on geospatial data is disclosed herein. The method can include retrieving contextual content data relevant to a geographic location, generating a context-conditioned media stream based on the retrieved contextual content, receiving geospatial data from a computing device, determining that the computing device is in the geographic location based on the geospatial data, and providing the computing device with access to the context-conditioned media stream based on determination that the computing device is in the geographic location based on the geospatial data.

### CROSS-REFERENCE TO RELATED APPLICATIONS

This application is a continuation-in-part and claims the benefit under 35 U.S.C. §119(e) of U.S. application Ser. No. 18/910,635 filed Oct. 9, 2024, titled DEVICES, SYSTEMS, AND METHODS FOR CUSTOMIZING A USER EXPERIENCE DURING A LIVE EVENT the contents of which is hereby incorporated by reference in its entirety herein.

### SUMMARY

In one general aspect, the present disclosure contemplates a computer-implemented method of customizing a user experience based on geospatial data, the method can include retrieving, via a host sub-system, contextual content data relevant to a geographic location, generating, via the host sub-system, a context-conditioned media stream based on the retrieved contextual content, receiving, via the host sub-system, geospatial data from a computing device, determining, via the host sub-system, that the computing device is in the geographic location based on the geospatial data, and providing, via the host sub-system, the computing device with access to the context-conditioned media stream based on determination that the computing device is in the geographic location based on the geospatial data.

In another general aspect, the present disclosure contemplates a system for customizing a user experience based on geospatial data. The system can include a control circuit and a memory configured to store a location-specific media engine that, when executed by the control circuit, causes the system to retrieve contextual content data relevant to a geographic location, generate a context-conditioned media stream based on the retrieved contextual content, receive geospatial data from a computing device, determine that the computing device is in the geographic location based on the geospatial data, and provide the computing device with access to the context-conditioned media stream based on determination that the computing device is in the geographic location based on the geospatial data.

In another general aspect, the present disclosure contemplates a method of customizing a user experience based on geospatial data, the method including acquiring, via a host sub-system, context for a particular geographic location; embedding, via the host sub-system, the context for the particular geographic location; generating, via the host sub-system, one or more candidate media items for a context-conditioned media stream based on the embedded context; scoring, via the host sub-system, the one or more candidate media items for the context-conditioned media stream based on the embedded context; and generating, via the host sub-system, the context-conditioned media stream based on the scores for the one or more candidate media items.

### BRIEF DESCRIPTION OF THE DRAWINGS

Various embodiments are described herein by way of example in connection with the following figures, wherein:

FIG. 1 illustrates a block diagram of a system configured to autonomously customize a user experience during a live event, according to at least one non-limiting aspect of the present disclosure;

FIG. 2 illustrates an algorithmic flow diagram of a method of initiating a live event via the system of FIG. 1, according to at least one non-limiting aspect of the present disclosure;

FIG. 3 illustrates an algorithmic flow diagram of a method of autonomously customizing a user experience during a live event via the system of FIG. 1, according to at least one non-limiting aspect of the present disclosure;

FIG. 4 illustrates an algorithmic flow diagram of another method of autonomously customizing a user experience during a live event via the system of FIG. 1, according to at least one non-limiting aspect of the present disclosure;

FIGS. 5A-5K illustrate several user interfaces of a media request application configured for use via the system 100 of FIG. 1, according to at least some non-limiting aspects of the present disclosure;

FIGS. 6A-6F illustrate several other user interfaces of a media request application configured for use via the system 100 of FIG. 1, according to at least some non-limiting aspects of the present disclosure;

FIG. 7 illustrates a diagrammatic representation of a computing device including a host machine within which a set of instructions to perform any one or more of the methodologies discussed herein may be executed, according to at least one non-limiting aspect of the present disclosure;

FIG. 8 illustrates a block diagram of a system configured to autonomously customize a user experience based on geospatial data, according to at least one non-limiting aspect of the present disclosure;

FIG. 9 illustrates a notification that includes a machine-readable code configured for use with the system of FIG. 8, according to at least one non-limiting aspect of the present disclosure;

FIG. 10 illustrates an algorithmic flow diagram of a method of autonomously customizing a user experience based on geospatial data, according to at least one non-limiting aspect of the present disclosure; and

FIG. 11 illustrates an algorithmic flow diagram of a method of generating and modifying a location-specific media stream, according to at least one non-limiting aspect of the present disclosure.

### DETAILED DESCRIPTION

The present invention is directed, in various embodiments, to computer systems and computer-implemented methods that enable a person to customize a user experience during a live event. Accordingly, these systems and methods can be applied to many different forms of live events or entertainment, including but not limited to musical performances, such as concerts and DJ performances, sporting events, any form of theatrical show, improvisational events, comedy shows, variety shows, live streams (e.g., video game demonstrations), e-sports (e.g., video game tournaments), trivia events, lectures, conferences, presentations, and/or exercise demonstrations or classes, amongst other live performances. According to some non-limiting aspects, this can include media presented in a venue (e.g., games, shows, or movies played in a bar). It shall be appreciated that any live event during which media can be streamed from a media server can benefit from the devices, systems, and methods disclosed herein as they can enable the customization of a user experience on behalf of a user, oftentimes autonomously and without active user participation.

As used herein, the expression “term” can include, in a broad sense, one aspect of an agreement between a user of the devices, systems, and methods disclosed herein and a live performer or automated system configured to play media at a live event. The user may have to agree to one or more “terms” that govern the use of the devices, systems, and methods disclosed herein to influence the live event. For example, a user may have to agree to a term specifying that they will be charged for the submission of a media request, regardless of whether or not the live performer fulfills that request during the live event.

As used herein, the expression “condition” can include a specific “term” that grants either the user of the devices, systems, and methods disclosed herein or the live performer at the live event a unilateral right or obligation under the agreement. A user may have to agree to a condition specifying that a request to the live performer will not be submitted until certain prerequisite qualifications of the terms are confirmed. For example, a financial institution server and/or host application server confirms that the user has a required balance in an account maintained with the financial institution. Alternately, a user may have to agree to a condition specifying that the live performer will only be obligated to fulfill that request during the live performance if the user outbids other users of the devices, systems, and methods disclosed herein. In other words, a particular “term” can be contingent on a particular “condition” of the agreement.

It shall be further appreciated that the expression “terms and conditions” is colloquially used to include all of the rules governing a contractual relationship between a provider of a product or service and a user of that product or service, regardless of whether the agreement is governed by a single “term” or a single “condition. ” Therefore, as used herein, collective use of the expression “terms and conditions” can refer to all of the provisions governing an agreement between a user of the devices, systems, and methods disclosed herein and a live performer at a live event, regardless of whether that agreement is governed by a single “term” or a single “condition.” The combined advent of mobile devices, WiFi®, high-speed cellular networks, and cloud computing has enabled the average consumer to access a seemingly endless supply of media from their pockets, on a whim. Despite this increased access to on-demand entertainment, live events such as musical performances, sporting events, and shows remain popular pastimes. Even smaller venues may hire a disc jockey (hereinafter “DJ”), a cover band, and/or a comedian to attract more customers. However, “users,” or attendees at such events, are typically passive consumers of live entertainment and are limited in the ways they can interact with a performer and/or influence a performance at such live events. This is especially true when compared to the on-demand nature of their entertainment consumption at home.

To the extent that known devices, systems, and methods for enabling the active consumption of live entertainment are available, manual intervention is typically required. There is no guarantee that a user will take the requisite steps to participate and therefore, most user experiences are not customized. Additionally, there exist technological challenges that prevent a fully autonomous system from dynamically customizing a user experience (e.g., controlling music) during a live event in a social setting, like a bar. For example, known devices, systems, and methods for enabling the active influence of live entertainment generally lack the use of location data and, therefore, prevent the technological optimization of a user experience.

Accordingly, for example, conventional technologies lack the ability to discern what music a user prefers to listen to at home relative to in a restaurant, bar, or club. For that matter, conventional technologies are incapable of continuously monitoring and analysing the mood, energy level, and preferences of a crowd. While sentiment analysis technologies (e.g., facial recognition, body language analysis, and sound level monitoring) may exist, interpreting crowd behavior accurately in real time is complex. User reactions to music can be subjective, and conventional technologies are incapable of detecting how a group of users is responding to a specific song because they lack and struggle with deep contextual understanding.

Additionally, conventional technologies and algorithms suffer from limited personalization techniques. While music recommendation systems like Spotify's algorithm may be good at personalizing playlists for individuals, group recommendation is much harder. The technology would need to integrate personal preferences from a large number of people in a way that feels coherent rather than random or generic, something that is still in development. For example, venues such as bars often host diverse crowds with varying musical tastes. Current algorithms, such as those used by music streaming services, can tailor playlists based on individual preferences but struggle to aggregate and satisfy the preferences of a large group in a dynamic environment. Balancing preferences across a group can be complicated and can require real-time decision-making, which current algorithms are not fully capable of. Certain venues, such as bars, may also have changing environments—busy nights, quieter nights, themed events, and more. Conventional devices, systems, and methods are incapable of adapting to these varying contexts.

Likewise, conventional devices, systems, and methods and algorithms lack continuous feedback mechanisms by which they can ascertain whether a performance is effective relative to user preferences. For instance, conventional devices, systems, and methods lack an ability to monitor a user's activity during a live performance, whether a user is enjoying a live performance, and/or when a user leaves a live performance and/or venue. Implementing such a real-time feedback loop would possible only if such devices, systems, and methods could account for other parameters that could influence user behavior, such as the ambiance, food/drink availability, and/or company. Additionally, conventional systems that use facial recognition and/or monitoring devices to gauge crowd reactions, implicant certain privacy issues that could be difficult for a venue to account for. Such restrictions impose technological limitations on the use of certain sensors to track sentiment or preferences that implicate sensitive data.

Although it may be possible to implement certain aspects of the functionality employed by the devices, systems, and methods disclosed herein in the human mind, it shall be appreciated that the sheer scale of users, data, and applications supported by the devices, systems, and methods disclosed herein would render it highly impractical, if not impossible, to do so. In summary, while some parts of the necessary technologies may exist, data aggregation, recommendation engines, and sentiment analysis are not presently integrated into a dependable, adaptive, and real-time system specifically configured to autonomously and predictively influence a live performer during a live event. The complexity of real-time group dynamics, privacy concerns, and the intricacies of human behavior remain significant hurdles. Accordingly, there is a need for devices, systems, and methods for autonomously customizing a user experience during a live event.

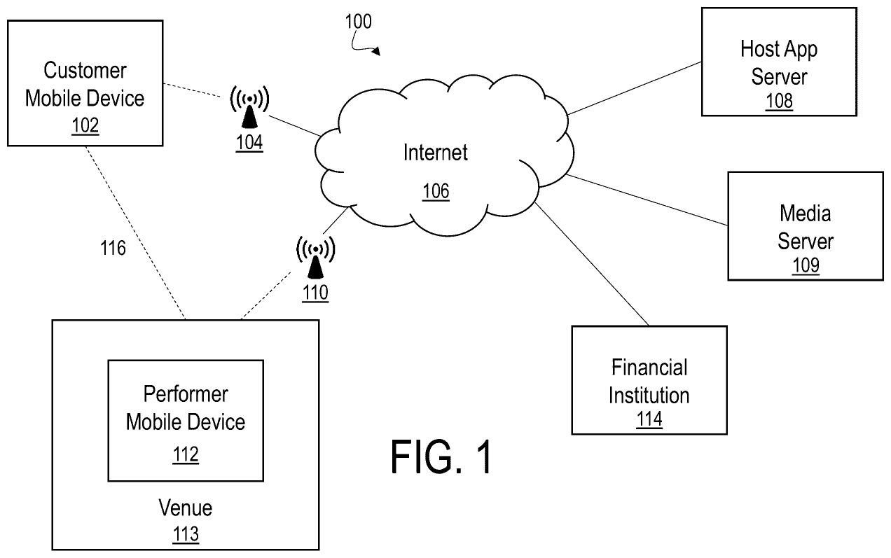

Referring now to FIG. 1, a block diagram of a system 100 configured to autonomously customize a user experience during a live event is depicted in accordance with at least one non-limiting aspect of the present disclosure. According to the non-limiting aspect of FIG. 1, the system 100 can include a customer mobile device 102, a performer mobile device 112 in a venue 113, one or more access points 104, 110 configured to connect the mobile devices 102, 112 to the internet 106, a host server 108, a music server 109, and a financial institution server 114. The customer mobile device 102 of FIG. 1 can be configured to connect to the internet 106 via an access point 104. The performer mobile device 112 can be configured to interact with either a human or automated performer. Non-limiting examples of the mobile devices 102, 112 can include a cell phone, a smart phone, a tablet, a wearable, a laptop, a personal digital assistant, or any other consumer electronic device configured to connect to the internet 106. In some non-limiting embodiments, the mobile devices 102, 112 may not be mobile in a conventional sense and thus, can include a personal desktop computer.

According to some non-limiting aspects of the present disclosure, the access point 104 of FIG. 1 can be configured to connect the customer mobile device 102 to the internet 106 via a wireless network such as WiFi®. In other non-limiting aspects, the access point 104 can be configured to connect the customer mobile device 102 to the internet 106 via a cellular network. In such aspects, the access point 104 can include a cellular tower. According to other aspects, the access point 104 can include a satellite. Therefore, the present disclosure contemplates aspects in which the access point 104 uses any conventional means of connecting the customer mobile device 102 to the internet 106. Because the customer mobile device 102 is connected to the Internet 106 the customer can use the system 100 to interact with a performer and/or influence a live event from any location. However, the present disclosure specifically contemplates non-limiting aspects wherein the customer mobile device 102 generates device-specific data, including location data, configured for use by the system 100 of FIG. 1 to influence a specific performer mobile device 112 in a specific venue 113.

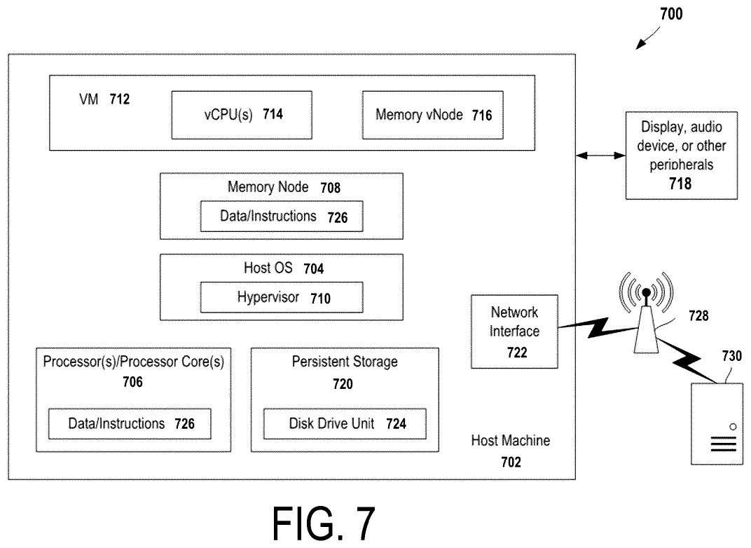

For example, according to the non-limiting aspect of FIG. 1, the customer mobile device 102 can include one or more systems, components, and/or techniques to generate location data, including a global positioning system (“GPS”) receiver, WiFi positioning technology, cell tower triangulation techniques, Bluetooth® beacons, IP addresses and/or sensor fusion, amongst others. As will be described in further detail with reference to FIG. 7, any components of the system 100—including the customer mobile device 102, the performer mobile device 112, and the host app server 108—can include one or more control circuits and/or memories configured to store a media request application that, when executed by the control circuit, causes the customer mobile device 102 to perform the functionality and methods described herein. The media request application can be specifically configured to cause the customer mobile device 102 to transmit requests as well as location information associated with a current geographic position of the customer mobile device 102 to the host server 108, the media server 109, the financial institution 114, and the performer mobile device 112 via the Internet 106. Likewise, the Host App Server 108, the media server 109, the financial institution 114, and the performer mobile device 112 can be configured to communicate with other components of the system 100 via the Internet. It shall be appreciated that, as used herein, the “media request application” associated with the host app server 108, shall be separate and removed from a “media server application” associated with the media server 109. Such separation enables the media request application and host app server 108 to provide users with functionality beyond what the media server application and media server 109 are otherwise capable of providing. It shall be further appreciated that, according to some non-limiting aspects, functionality ascribed to the host app server 108 herein can be incorporated into the customer mobile device 102 and vice versa.

In further reference to FIG. 1, the host app server 108 can be configured to store data and content needed by the media request application, including login credentials, personal information, financial information, preferences, request history, location history, and other content associated with the media request application, as used by the customer mobile device 102. According to some non-limiting aspects, the host app server 108 can be configured to store an algorithmic model that, when executed by the control circuit, can cause the host app server 108 to perform at least a subset of the functionality and/or methods disclosed herein. As will be described in further detail herein, according to other non-limiting aspects, the algorithmic model can include an artificial intelligence model configured to autonomously customize a user experience during a live event, without requiring active participation from a user of the customer mobile device 102. It shall be appreciated, therefore, that the host app server 108 can offload processing functionality that would otherwise be required of the customer mobile device 102, the performer mobile device 112, and/or the media server 109, resulting in a more efficient system that requires less overall computational resources required by the system 100.

Additionally, the model can cause the host app server 108 to enable real-time communication between other components of the system 100, such as the customer mobile device 102 and the performer mobile device 112 by managing connections and facilitating the efficient transfer of compliant communications in real-time. This can enable the system 100 to assess the sentiment of users more effectively in the venue 113 and more accurately customize the user experience during the live event, as conducted by the performer mobile device 112. The host server app 108 can further function as an intermediary between the customer mobile device 102, the music server 109, and the performer mobile device 112, enabling users via a customer mobile device 102 to interact with and influence content (e.g., playlists) hosted by the music server 109 in association with an account utilized by the performer mobile device 112, without providing the customer mobile device 102 with direct access to the music server 109 and/or the account utilized by the performer mobile device 112. In other words, due to the host app server 108, a user of the customer mobile device 102 need not have an account on the media server 109 in order to utilize the system 100 to autonomously customize a user experience during a live event.

It shall be further appreciated that the host app server 108 can enable users to seamlessly create an account on the system 100 of FIG. 1 via a OAuth 2.0 authentication protocol. For example, assuming a user of the performer mobile device 112 has an account associated with the media server 109, the user of the performer mobile device 112 can easily create a system 100 account via the account associated with the media server 109. The host app server 108 and media server 109 can be communicatively coupled via an application programming interface (API) associated with the media server 109. For example, upon receiving an account initiation request—including credentials associated with the media server 109 account—from the performer mobile device 112, the host app server 108 can be configured to utilize the provided credentials to access the media server 109 and generate a system 100 account based on data stored on the media server 109 in association with the media server 109 account. According to some non-limiting aspects, the media server 109 can initiate a two-factor authentication protocol via the performer mobile device 112, independent of the host app server 108, to ensure that the request of the host app server 108 was actually authorized by the performer mobile device 112. As such, it shall be appreciated that the host server 108 can enable more efficiency on behalf of system 100 users while enhancing the security of the overall system 100.

Still referring to the non-limiting aspect of FIG. 1, the media server 109 can be configured to host a media service on behalf of the performer mobile device 112. For example, the performer mobile device 112 can access and play media (e.g., music, videos, lectures, audio books, live streams, etc.) stored on the media server 109 during a live performance hosted at the venue 113 by accessing the media server 109 via the Internet 106 using a media server 109 account. The media server 109 can store the requested media, process the transmission of media data from a source, and/or otherwise access the requested media. For example, the media server 109 can be configured to host a plurality of digital media files, sometimes in a cloud-based infrastructure. The files, for example, can be encoded using an efficient compression format, such as Ogg Vorbis or ACC to reduce the file size without a noticeable loss in media quality. In response to a media request transmitted via a user input provided by a media server 109 application stored and executed by the performer mobile device 112, the media server 109 can identify a hosted media file associated with the request and begin buffering a portion of the file such that playback can be immediately initiated via the performer mobile device 112 while the rest of the file downloads. The media server 109 can be further configured to adjust the media quality via several techniques, including adaptive bitrate streaming, which dynamically changes the quality based on a speed of connection by which the performer mobile device 112 is accessing the Internet 106. For example, if the connection weakens, the media server 109 can adjust the quality to preserve continuous playback of the media via the performer mobile device 112 without interruption.

According to some non-limiting aspects, the media server 109 of the system 100 of FIG. 1 can implement a peer-to-peer protocol by which a load is reduced on the overall system 109. According to such protocols, the media server 109 distributes portions of media files across a plurality of devices, including the customer mobile device 102, host app server 108, and performer mobile device 112, for example, such that the ultimate functionality is achieved without overloading or overclocking any one component of the system 100. According to some non-limiting aspects, the media server 109 can include one or more edge servers for real-time data processing, which can benefit in monitoring user interactions, managing metadata, and customizing content on behalf of the customer mobile device 102 and performer mobile device 112 via intermediary interactions provided by the host app server 108. According to still other non-limiting aspects, the media server 109 can be specifically configured to ingest the media via specific protocols (e.g., real-time messaging protocols, secure reliable transport, WebRTC, etc.), encode the media into a digital format compatible with the performer mobile device 112 (e.g., H264, H265, etc.), and/or transcode the video into different formats and/or resolutions, thereby optimizing a user experience regardless of Internet speed. According to some non-limiting aspects, the media server 109 can include a content delivery network, or a network of geographically distributed servers that store and deliver media content to the performer mobile device 112 and/or customer mobile device 102 based on geographic data associated with the performer mobile device 112 and/or customer mobile device 102. It shall be appreciated, however, that by utilizing one or more edge servers of the media server 109 can further improve scalability, supporting far more customer mobile devices 102 and performer mobile devices 112 than conventional technologies, optimize bandwidth utilization of the overall system 100 and reduce latency provided via conventional content delivery networks.

According to the non-limiting aspect of FIG. 1, the media server 109 can be configured to manage digital rights one behalf of the system 100. For example, in the same way that the host app server 108 enables users of customer mobile devices 102 to interact with a media server 109 account associated with he performer mobile device 112 without having a media server 109 account of their own, it shall be appreciated that—by interfacing and interacting with the media server 109—neither the customer mobile device 102 nor the host app server 108 need worry about the management or infringement of digital rights associated with media hosted by the media server 109. Conventional technologies require that a customer mobile device 102 or host app server 108 maintain their own media server 109 accounts and obtain their own licenses, (e.g., by downloading and hosting their own version of the media server 109 application, which gates access to the media server 109 via individual media server 109 accounts for the customer mobile device 102 and host app server 108). However, according to the non-limiting aspect of FIG. 1, the media server 109 can maintain all licenses and prevent unauthorized copying or redistribution of the media it hosts on behalf of the overall system 100. Therefore, it shall be appreciated that the system 100 enables a customized user experience on behalf of the customer mobile device 102, which transmits media requests and preferences to the host app server 108, and the host app server 108, which manages media requests sent by the customer mobile device 102. Accordingly, it shall be appreciated that the system 100 of FIG. 1 enables the participation in a customized user experience beyond the functionality of conventional technologies.

It shall be further appreciated that, according to some non-limiting aspects, media requests generated by the customer mobile device 102 of the system 100 of FIG. 1 can include supplemental data (e.g., geographic data, sensor data) generated the customer mobile device 102, which can influence how the host app server 108 processes the media request, thereby further enhancing autonomous customization of the user experience during the live event. For example, media requests generated by the customer mobile device 102 can include geographic data generated by the customer mobile device 102. Aside from using the geographic data to process a specific media request (e.g., confirm the user of the customer mobile device 102 is within or in proximity of the venue 113), the host app server 108 can be configured to track geographic data associated with media requests transmitted by customer mobile devices 102. Accordingly, the system 100 can be specifically configured to generate specific insights as to what media is requested in a particular location of a plurality of locations. Such insights, for example, can include specific media that users request in particular venues, such as a residence, as compared to a bar, restaurant, a gym, a school, a club, etc.

According to some non-limiting aspects, media requests provided by the customer mobile device 102 of the system 100 of FIG. 1 can include activity data generated by one or more sensors (e.g., accelerometers, cameras, gyroscopes, microphones, etc.) or applications (e.g., health applications) associated with the customer mobile device 102. Similarly, the system 100 can be specifically configured to generate specific insights as to what media is requested when a user of the customer mobile device 102 is participating in particular activities (e.g., sitting, walking, working, running, working out, etc.). Such insights, for example, can be implemented to determine where and how a performer associated with the performer mobile device 112 or another performer performs in future live events (e.g., venue selection, media selection, etc.).

According to other non-limiting aspects, media requests can include sensor data generated by one or more sensors (e.g., accelerometers, cameras, gyroscopes, microphones, etc.) associated with the customer mobile device 102, wherein the sensor data can be used to assess and ascertain an environment of the venue 113. For example, the sensor data can include audio data generated by a microphone of the customer mobile device 102 or image data generated by a camera of the customer mobile device 102, which the host app server 108 can use to assess a number of attendees at the venue 113 and/or a noise level associated with the venue 113, thereby enabling the system 100 to assess the environment (e.g., vibe, feel, mood, etc.) and factor the assessment into the processing of media requests to customize the user experience on behalf of the customer mobile device 102. Although media requests may be limited to media specified on a plurality of acceptable media as defined by a performer associated with the performer mobile device 112, the host app server 108 may determine that fulfilling a particular media request may not be appropriate based on the assessed environment. For example, even if a heavy metal song is included on a playlist of available songs to be played by the performer, the host app server 108 may determine that playing the heavy metal song is inappropriate if the sensor data indicates that the environment is low key (e.g., low number of attendees, low volume, etc.). It shall be appreciated that the sensor data, geographic data, and/or applications can be accessed by the media request application via a setting of the customer mobile device 102 and/or APIs that interface with ancillary applications associated with the customer mobile device 102.

According to some non-limiting aspects, the system 100 can be configured to use geographic data associated with the customer mobile device 102 to passively customize a user experience during a live event hosted at the venue 113. In other words, the user does not have to actively initiate and transmit a media request to the host server 108 via a provision of a real-time user input. Rather, upon initially logging into the media request application and setting up a media request application account via the customer mobile device 102, the user can establish user settings and/or preferences (e.g., preferred songs, artists, genres, etc.). Such settings and/or preferences can be transmitted to and stored on the host app server 108. After initialization, manual intervention of the user need not be required. For example, the media request application can cause the customer mobile device 102 to continually transmit geographic data to the host app server 108. Upon receipt, the host app server 108 can correlate geographic information received from the customer mobile device 102 to geographic information associated with the venue 113 to host a live event or session, as initiated by a performer via the performer mobile device 112. Assuming the host app server 108 can successfully correlate the geographic information received from the customer mobile device 102 to geographic information associated with the venue 113, the host app server 108 may apply the stored settings and/or preferences associated with the media request application account to generate a media request on behalf of a user of the customer mobile device 102 or otherwise influence the processing of other media requests, including those actively generated by other users associated with other customer mobile devices 102.

For example, when a user of the customer mobile device 102 enters a venue 113, the media request application can transmit geographic data associated with the customer mobile device 102 and the host app server 102 can correlate the geographic data associated with the customer mobile device 102 to an event established by the performer to take place in the venue 113 at that particular time. The host app server 108 can subsequently and autonomously access the settings and/or preferences associated with the user of the customer mobile device 102 and asses, for example, if a particular song included in the settings and/or preferences is included on a playlist of available songs established by the performer and to be played by the performer in the venue 113 during the live event. If, for example, the song included in the settings and/or preferences is in fact included on a playlist of available songs established by the performer, the host app server 108 can generate and process a media request for that song to be played autonomously, without manual intervention of the user of the customer mobile device 102. However, if the song included in the settings and/or preferences is not included on the playlist of available songs established by the performer, the host app server 108 may generate and process a media request for a comparable song on the playlist, including songs by the same artist or of similar genres. Accordingly, the host app server 108 can generate and process a media request for the comparable song to be played autonomously, without manual intervention of the user of the customer mobile device 102. It shall be appreciated, therefore, that the system 100 can ensure that, every time a user associated with a customer mobile device enters a venue 113 (e.g., a stadium, an auditorium, a bar, a restaurant, a club, etc.) hosting a live event, that user is autonomously influencing the performance, ensuring their input as to what media is being played is accounted for in the performance.

In further reference to FIG. 1, the financial institution server 114 can be configured to host a financial account associated with a user of the customer mobile device 102. For example, the financial institution server 114 can include a bank that maintains and manages a bank account the customer has linked to their user profile, which is stored in the host server 108. Additionally, and/or alternatively, the financial institution 114 can be a third-party service, such as PayPal®, Square®, or the like. According to some non-limiting aspects, the financial institution server can include a credit card server, a cryptocurrency exchange, and/or a blockchain network configured to host a distributed ledger that manages ownership and transactions of digital assets. Essentially, the financial institution server 114 of FIG. 1 represents any server capable of processing a payment on behalf of the host app server 108. Once the financial institution server 114 processes a payment, the host app server 108—via an API associated with the financial institution server 114—can be configured to receive a confirmation that the payment has been processed to the customer mobile device 102 and/or performer mobile device 112. Likewise, the host app server 108 can transmit a confirmation that the payment has been processed to the customer mobile device 102 via an API associated with the host app server 108. For example, according to some non-limiting aspects, the host app server 108 may implement a term and/or condition associated with a media request. Some terms and/or conditions contemplated by the present disclosure may require or optionally include a payment (e.g., a payment as a condition of the request, a tip for the performer, etc.), a purchase of a good or service provided at, by, or in association with the venue 113 or performer, an auction, and/or a crowdsourcing goal (e.g., a cumulative financial threshold must be exceeded prior to processing the same media request transmitted by a plurality of customer mobile devices 102), amongst other transactions. As such, the host app server 108 can forward the request to the financial institution server 114 for processing prior to managing the media request transmitted by the customer mobile device 102. Once the host app server 108 receives a confirmation from the financial institution server that the payment has been processed and similarly confirms that all additional terms and/or conditions associated with the request have been satisfied, only then will the host app server 108 manage the media request transmitted by the customer mobile device 102.

It shall be further appreciated that, according to some non-limiting aspects, the terms and/or conditions contemplated by the present disclosure do not involve a monetary transaction. For example, according to some non-limiting aspects, the terms and/or conditions can include acceptance of a privacy policy associated with the host app server 108, acceptance of a data policy associated with the host app server 108, participation in a survey, various social media interactions (e.g., “liking” an account or post associated with the venue 113, performer and/or sponsored product, sharing an account or post associated with the venue 113, performer and/or sponsored product, commenting on an account or post associated with the venue 113, performer sponsored product, posting and providing a required hash-tag, etc.), a location the customer mobile device 102—as confirmed via geographic data provided by the customer mobile device 102, reading of a machine-readable code located at or in proximity with the venue 113 (e.g., a UPC, a QR code, an audible code, etc.), a voting scheme, provision of user data (e.g., email address, phone number, name, etc.), redemption of a code or offer via the media request application hosted by the customer mobile device 102, user interaction with a sponsored link provided via the media request application hosted by the customer mobile device 102, and/or the customer mobile device 102 visiting a particular website, amongst others. Similar to the aforementioned interactions between the host app server 108 and the financial institution server 114, the host app server 108 can be configured to monitor the completion of such terms and/or conditions. According to some non-limiting aspects, the host app server 108 can monitor the completion of terms and/or conditions via various APIs, including APIs associated with the host app server 108 and/or various websites, social media services, etc.

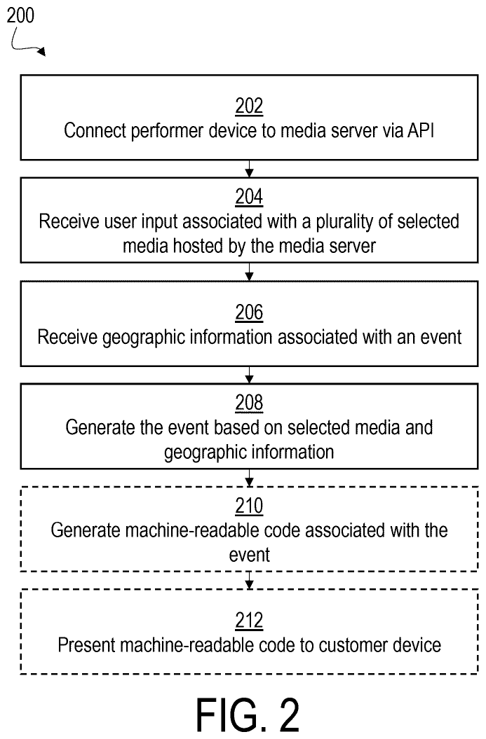

Referring now to FIG. 2, an algorithmic flow diagram of a method 200 of initiating a live event via the system of FIG. 1 is depicted in accordance with at least one non-limiting aspect of the present disclosure. The method 200 of FIG. 2 can be executed by a performer mobile device 112 (FIG. 1) of the system 100 of FIG. 1 in response to the media request application being executed by one or more processors of the performer mobile device 112 (FIG. 1). However, it shall be appreciated that, according to other non-limiting aspects, the method 200 can be performed by any other component of the system 100 of FIG. 1, or by combinations of components thereof.

According to the non-limiting aspect of FIG. 1, the method 200 can include connecting 202 the performer mobile device (112) to the media server 109 (FIG. 1) via an API. As previously described, the connection can include use of an OAuth 2.0 authentication protocol. For example, assuming a user of the performer mobile device 112 (FIG. 1) has an account associated with the media server 109 (FIG. 1), the user of the performer mobile device 112 (FIG. 1) can easily create a system 100 (FIG. 1) account via the account associated with the media server 109 (FIG. 1) and connect the media request application to the media server 109 (FIG. 1) via those credentials. According to some non-limiting aspects, the media server 109 (FIG. 1) can initiate a two-factor authentication protocol via the performer mobile device 112 (FIG. 1), independent of the host app server 108 (FIG. 1), to ensure that the request of the host app server 108 (FIG. 1) was actually authorized by the performer mobile device 112 (FIG. 1).

The method 200 of FIG. 2 can further include receiving 204 a user input associated with a plurality of selected media hosted by the media server. According to some non-limiting aspects, the selected media can include all of the media hosted by the media server 109 (FIG. 1). However, according to other non-limiting aspects, the selected media can include a subset (e.g., playlist) of the media hosted by the media server 109 (FIG. 1), thereby limiting media requests to media included in the subset. For example, the performer may determine that certain media hosted by the media server 109 (FIG. 1) is more appropriate for the venue 113 (FIG. 1) rather than other media hosted by the media server 109 (FIG. 1). According to some non-limiting aspects, the subset can include sponsored media. For example, the performer may agree with an artist to feature one or more media files, which can be included or even highlighted in the subset to attract attention from the attendees. According to some non-limiting aspects, the system 100 (FIG. 1) can be configured to ensure that sponsored media is played. According to still other non-limiting aspects, the system 100 (FIG. 1) can be configured to attribute a certain number of media requests and/or data associated with media requests (e.g., votes, bids, etc.) to sponsored media to maintain the integrity of the system 100 (FIG. 1). The method 200 can further include receiving 206 geographic information associated with the event. For example, the geographic information can be associated with an address of the venue 113 (FIG. 1). As such, the method 200 can further include generating 208 the event based on selected media and geographic information. Upon generation, the event is available in the media request application and can be viewed by the customer mobile device 102 (FIG. 1) and managed by the host app server 108 (FIG. 1). According to some non-limiting aspects, the method 200 can include generating 210 a machine-readable code associated with the generated event and presenting 212 the machine-readable code to be interpreted by the customer mobile device 102 (FIG. 1). For example, the machine-readable code can include a QR code, a UPC, and RFID, and/or an audible signal, and any other code including a unique identifier assigned to the event. Upon interpreting the machine-readable code, the customer mobile device 102, via the media request application, can access the generated event and generate a media request associated with the event.

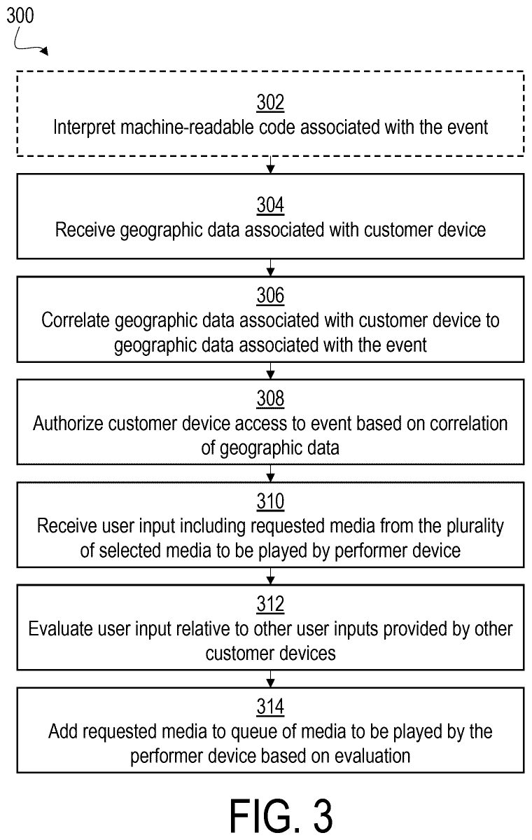

Referring now to FIG. 3, an algorithmic flow diagram of a method 300 of autonomously customizing a user experience during a live event via the system of FIG. 1 is depicted in accordance with at least one non-limiting aspect of the present disclosure. The method 300 of FIG. 3 can be executed by a host app server 108 (FIG. 1) of the system 100 of FIG. 1 in response to the media request application being executed by one or more processors of the host app server 108 (FIG. 1). However, it shall be appreciated that, according to other non-limiting aspects, the method 300 can be performed by any other component of the system 100 of FIG. 1, or by combinations of components thereof.

According to the non-limiting aspect wherein the method 200 of FIG. 2 includes generating 210 (FIG. 2) a machine-readable code associated with the generated event and presenting 212 (FIG. 2) the machine-readable code to be interpreted by the customer mobile device 102 (FIG. 1), the method 300 of FIG. 3 can include interpreting 302 the machine-readable code associated with the event. Regardless, the method 300 can include receiving 304 geographic information associated with the customer mobile device 102 (FIG. 1) accessing the event and correlating 306 geographic data associated with customer mobile device (FIG. 1) to geographic data associated with the event. Assuming the geographic information associated with customer mobile device 102 (FIG. 1) is properly correlated to the geographic information associated with the event, the method 300 can further include authorizing the customer device to access to event via the media request application based on correlation. In other words, the method 300 of FIG. 3 ensures that the user of the customer mobile device (FIG. 1) is actually located at the venue 113 (FIG. 1) prior to allowing the user of the customer mobile device (FIG. 1) to influence the live event. According to the non-limiting aspect wherein no manual intervention is required of the user of the customer mobile device 102 (FIG. 1), the media request application can autonomously and continuously transmit geographic data associated with the customer mobile device 102 (FIG. 1) to the host app server 108 (FIG. 1).

Still referring to FIG. 3, the method 300 can further include receiving 310 a user input including requested media from the plurality of selected media to be played by performer mobile device 112 (FIG. 1). This user input, for example, can be provided via a media request generated and transmitted by the customer mobile device 102 (FIG. 1), which receives the user input. For example, upon successfully accessing the event, the customer mobile device 102 (FIG. 1) can display the plurality of selected media to the user via the media request application. However, according to the non-limiting aspect wherein no manual intervention is required of the user of the customer mobile device 102 (FIG. 1), the host app server 108 (FIG. 1) can retrieve initial user inputs it stored based on user settings and/or preferences and autonomously generate a media request on behalf of the user of the customer mobile device 102 (FIG. 1). Regardless, the method 300 can further include evaluating 312 the user input relative to other user inputs provided via other media requests associated with other customer mobile devices 102 (FIG. 1). In other words, if there is a term and/or condition associated with the media requests, those shall be considered by the host app server 108 (FIG. 1). For example, media requests that do not comply with the terms and/or conditions may be discarded. If the terms and/or conditions require a voting scheme, media requested by the media requests shall be tallied and the most requested media will be added to a queue of media to be played by the performer mobile device 112 (FIG. 1). If the terms and/or conditions require an auction, bids associated with each of the media requests shall be tallied and the media request associated with the highest bid will be added to a queue of media to be played by the performer mobile device 112 (FIG. 1), pending confirmation from the financial institution server 114 (FIG. 1). Of course, other terms and/or conditions can attenuate the evaluation process accordingly, including those previously described. Finally, the method 300 can include adding 314 the requested media to a queue of media to be played by the performer device based on the evaluation.

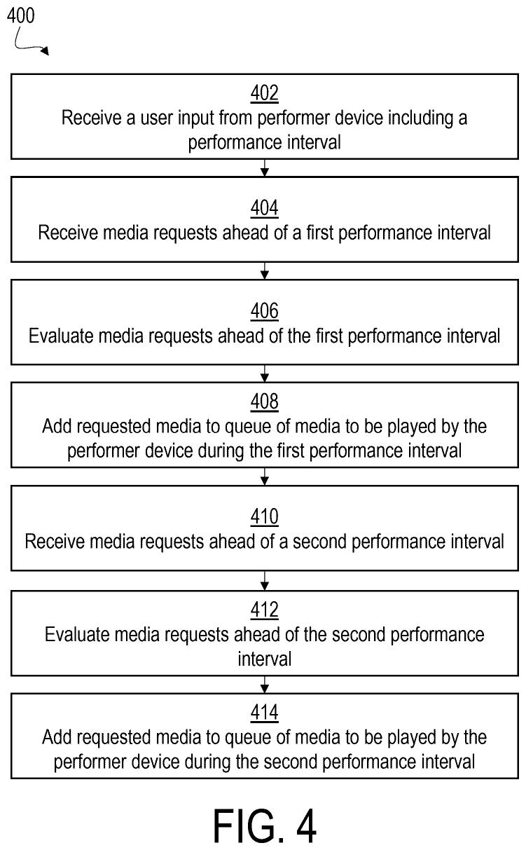

Referring now to FIG. 4, an algorithmic flow diagram of another method 400 of autonomously customizing a user experience during a live event via the system of FIG. 1 is depicted in accordance with at least one non-limiting aspect of the present disclosure. The method 400 of FIG. 4 can be executed by a host app server 108 (FIG. 1) of the system 100 of FIG. 1 in response to the media request application being executed by one or more processors of the host app server 108 (FIG. 1). However, it shall be appreciated that, according to other non-limiting aspects, the method 300 can be performed by any other component of the system 100 of FIG. 1, or by combinations of components thereof.

According to the non-limiting aspect of FIG. 4, the method 400 can include receiving 402 a user input from the performer mobile device 402 (FIG. 4) including a performance interval. For example, the performance interval can include a predetermined amount of time by which the host app server 108 (FIG. 1) evaluates media requests, as specified in reference to the method 300 of FIG. 3. The method 400, therefore, can include receiving 404 media requests ahead of the first performance interval and evaluating 406 the media requests ahead of the first performance interval. Based on the evaluation, the method 400 can further include adding 408 requested media to a queue of media to be played by the performer mobile device 112 (FIG. 1) based on the evaluation. While the media is being played off the queue by the performer mobile device 112 (FIG. 1) during the first interval, the method 400 can further include receiving 410 media requests ahead of a second performance interval, evaluating 412 media requests ahead of the second performance interval, and adding 414 the requested media to queue of media to be played by the performer device during the second performance interval. In this way, the method 400 can ensure a dynamic influence of the performance, accounting for continual active or passive participation from attendees throughout the live event at the venue 113 (FIG. 1).

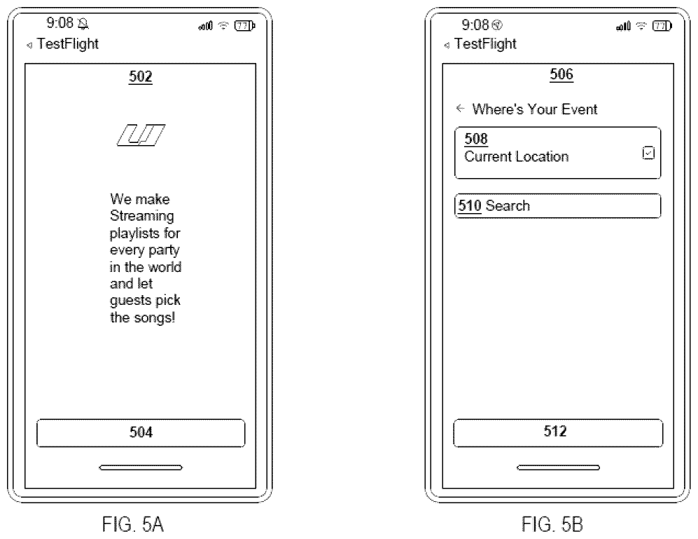

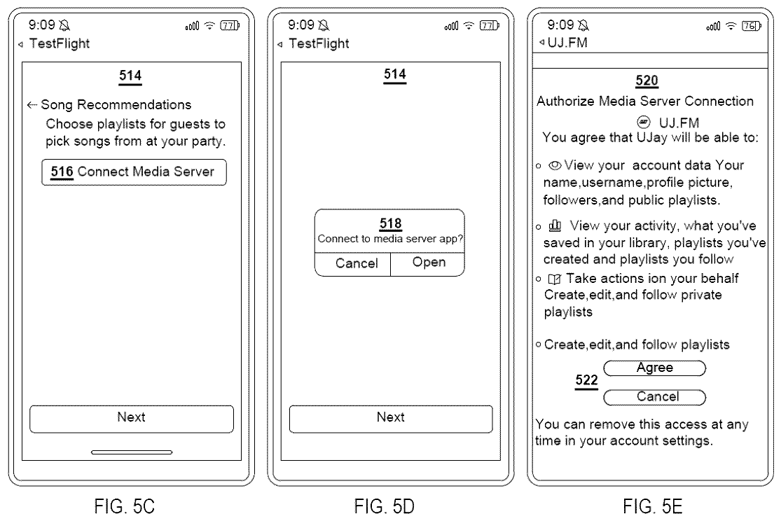

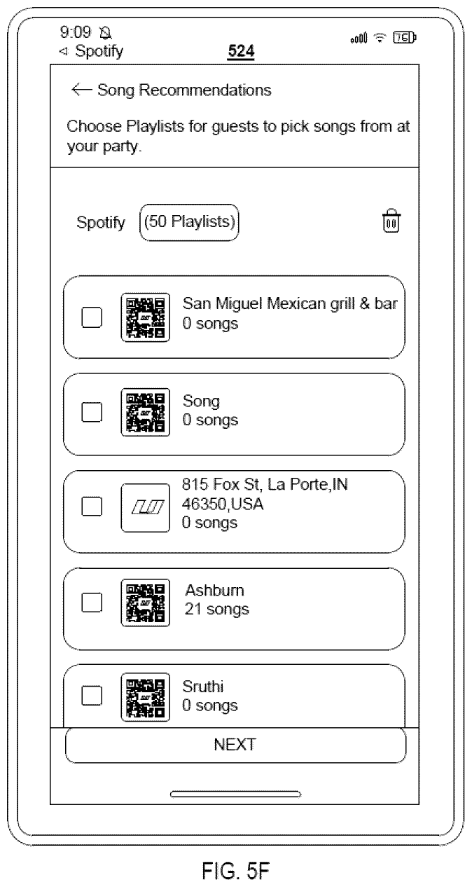

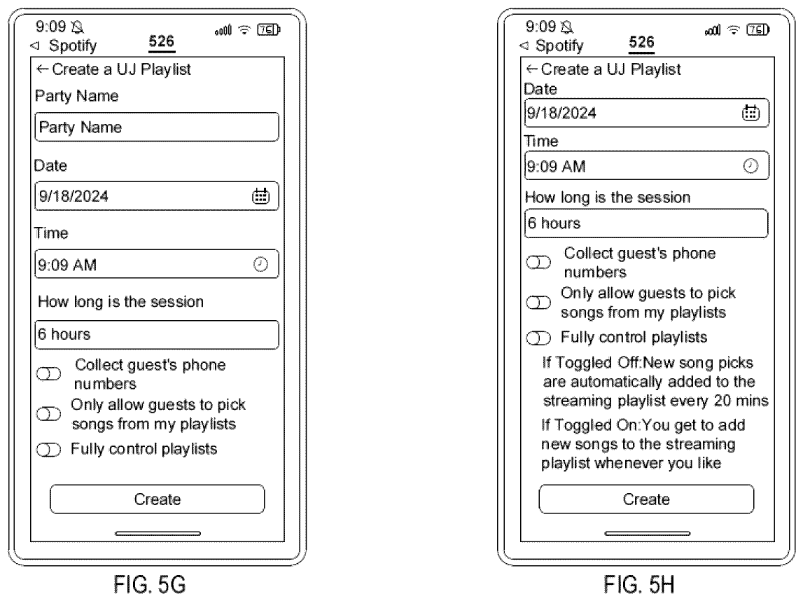

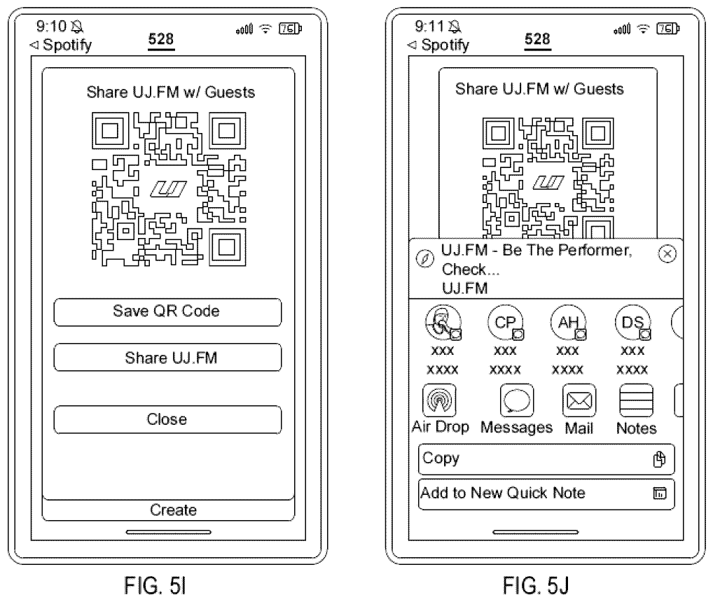

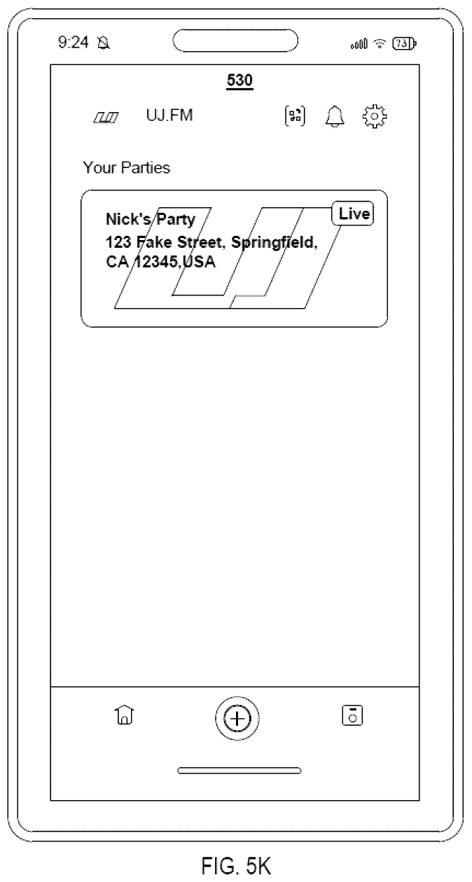

Referring now to FIGS. 5A-5K, several user interfaces of a media request application configured for use via the system 100 of FIG. 1 are depicted in accordance with at least one non-limiting aspect of the present disclosure. For example, the user interfaces of FIGS. 5A-5K can be configured for display via the performer mobile device 112 (FIG. 1). However, it shall be appreciated that, according to other non-limiting aspects, the user interfaces of FIGS. 5A-5K can be configured for display via any other system 100 (FIG. 1) component. According to some non-limiting aspects, at least portions of the user interfaces of FIGS. 5A-5K can be provided or otherwise supported via the host app server 108 (FIG. 1). According to the non-limiting aspect of FIG. 5A, a first user interface 502 can be configured to welcome a user, such as a performer, to the system 100 (FIG. 1), including a widget 504 by which the user can create a session or live event, including a plurality of selected media from the media server 109 (FIG. 1) to be made available to attendees at the session or live event hosted at the venue 113 (FIG. 1). Upon user interaction with the widget 504, the system 100 (FIG. 1) can initiate a second interface 506, as illustrated in FIG. 5B. The second user interface 506, for example, can enable the user to attribute geographic data to the desired event. For example, the second user interface 506 can include a second widget 508, which can enable the user to utilize the aforementioned location identifying hardware and techniques to identify a current location of the performer mobile device 112 (FIG. 1), such that the system 100 (FIG. 1) utilizes the identified current location of the performer mobile device 112 (FIG. 1) as the event location. Additionally, the second user interface 506 can include a third widget 510, which can enable the user to search for a specific address or landmark to be associated with the desired event.

According to the non-limiting aspect of FIG. 5C, a third user interface 514 can include a fourth widget 516 configured to enable the user to connect to the media server 109 (FIG. 1) to select a plurality of media to be made available to attendees at the session or live event hosted at the venue 113 (FIG. 1). Upon interacting with the fourth widget 516, the third user interface 514 a window 518 will present a window 518 requesting the user to confirm a connection to a media server application associated with the media server 109 (FIG. 1), as depicted in FIG. 5D. This will initiate a fourth user interface 520, as depicted in FIG. 5E, which presents terms associated with the connection and a fifth widget 522 by which the user can agree to or cancel the connection based on the terms. Upon connecting to the media server 109 (FIG. 1), a fifth user interface 524 can enable the user to select a plurality of media to be made available to attendees at the session or live event hosted at the venue 113 (FIG. 1). For example, the media can be selected to be customized to the event or venue (e.g., if the event is taking place at a Mexican restaurant, Mexican music may be selected). FIGS. 5G and 5H depict a sixth user interface 526, which can enable the user to enter additional details associated with the live event. This can include a date of the event, a time of the event, a session duration, according to the non-limiting aspect of FIG. 4, and configuration by which attendee information from a customer mobile device 102 (FIG. 1) or control/limit media played during the live event. Such settings can control whether new media requests are automatically added to a playlist during the duration (e.g., every 20 minutes) or if the performer gets to control what media requests are or are not fulfilled. According to some non-limiting aspects, this information can include particular parameters and/or rules associated with a term and/or condition to be associated with the media request, as previously described.

FIGS. 5I and 5J depict a seventh user interface 528 by which a user can cause the performer mobile device 112 (FIG. 1) and/or host app server 108 (FIG. 1) to generate a unique, machine-readable code associated with the live event generated in reference to FIGS. 5A-5G. As previously described, upon reading the machine-readable code, a customer mobile device 102 (FIG. 1) can connect to the live event and generate media requests to be played via the performer mobile device 112 (FIG. 1) during the live event. The user interface 528 can enable a user to share the machine-readable code with attendees, as depicted in FIG. 5J. Of course, alternately, a user can search for and otherwise identify generated events, via geographic data and/or searching for the venue 113 (FIG. 1) or other identifying information, as provided via the sixth user interface 526 of FIGS. 5G and 5H. Upon successful generation of the live event, an eighth user interface 530 can display the generate event and any other events generated by the live performer, as depicted in FIG. 5K.

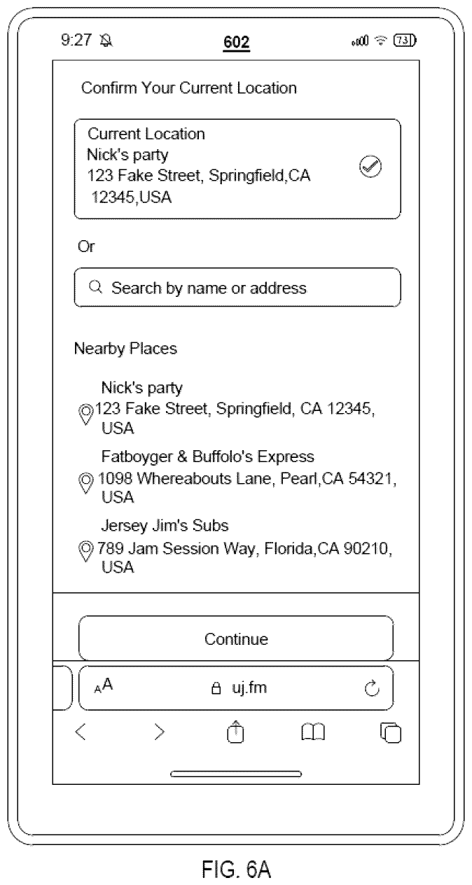

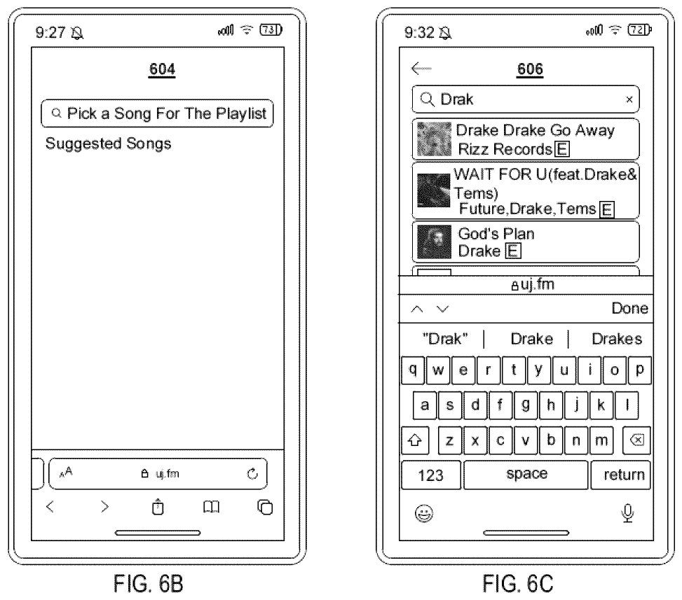

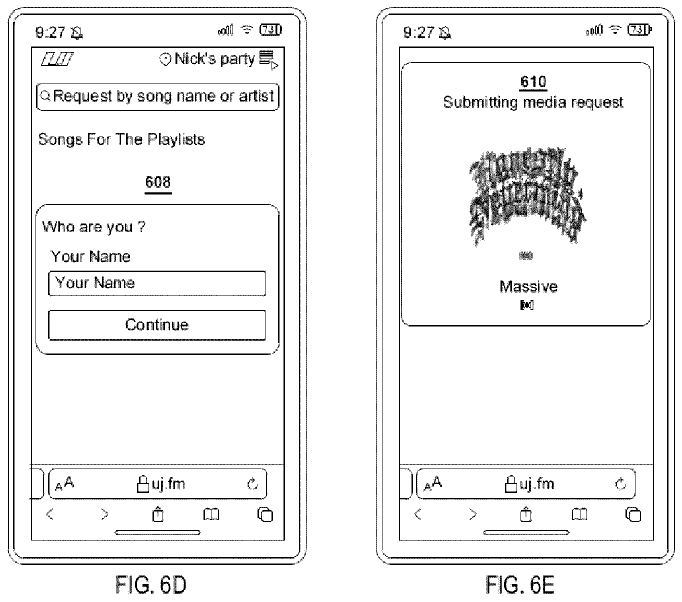

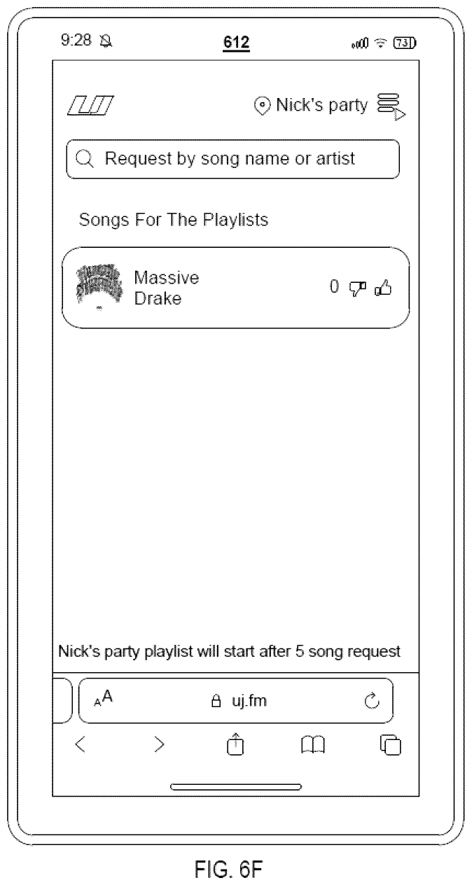

Referring now to FIGS. 6A-6F, several other user interfaces of a media request application configured for use via the system 100 of FIG. 1 are depicted in accordance with at least some non-limiting aspects of the present disclosure. For example, the user interfaces of FIGS. 6A-6F can be configured for display via the customer mobile device 102 (FIG. 1). However, it shall be appreciated that, according to other non-limiting aspects, the user interfaces of FIGS. 6A-6F can be configured for display via any other system 100 (FIG. 1) component. According to some non-limiting aspects, at least portions of the user interfaces of FIGS. 6A-6F can be provided or otherwise supported via the host app server 108 (FIG. 1). According to the non-limiting aspect of FIG. 6A, a ninth user interface 602 can prompt a user to provide a location of a live event they would like to influence. As previously described, this can be automatically assessed via the media request application based on the location identifying hardware and techniques previously described. Alternately, the ninth user interface 602 can provide the user with a list of nearby events or enable a user to search for a specific event. According to some non-limiting aspects, the media request application can autonomously and continually send the host app server 108 (FIG. 1) geographic data generated by the customer mobile device 102 (FIG. 1) without require manual or active participation of the user via the ninth user interface 602. As such, the host app server 108 (FIG. 1) always autonomously knows if the user is at an event and can autonomously generate media requests on their behalf.

In reference to FIG. 6B, a tenth user interface 604 can prompt the user to pick media to be included in a media request. This can launch an eleventh user interface 606, as depicted in FIG. 6C, which lists media (e.g., songs) that from the plurality of selected media programmed by the performer for the live event, as previously described. The eleventh user interface 606 enables a user to either view and select media or search for specific media. A twelfth user interface 608, as depicted in FIG. 6D, can prompt a user to provide additional information associated with the media request, including any actions or information necessary to fulfill the aforementioned terms and/or conditions, which can be associated with the media request. A thirteenth user interface 610 can confirm that the media request has been successfully submitted to the host app server 108 for fulfillment. Finally, FIG. 6F depicts a fourteenth user interface 612 that can enable the user to view their pending media requests and provide a status of the media request. As depicted in FIG. 6F, the fourteenth user interface 612 can provide other information associated with the media request (e.g., how many other attendees have requested the media) and can enable the user to provide feedback associated with the media request.

Referring now to FIG. 7, a diagrammatic representation of a computing device 700 including a a host machine 702 within which a set of instructions to perform any one or more of the methodologies discussed herein may be executed is depicted in accordance with at least one non-limiting aspect of the present disclosure. The computing device 700 can be representative of an component of the system 100 shown in FIG. 1. In various aspects, the host machine 702 operates as a standalone device or may be connected (e.g., networked) to other machines. In a networked deployment, the host machine 702 may operate in the capacity of a server or a client machine in a server-client network environment, or as a peer machine in a peer-to-peer (or distributed) network environment. The host machine 702 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 700 includes the host machine 702, running a host operating system (OS) 704 on a processor or multiple processor(s)/processor core(s) 706 (e.g., a central processing unit (CPU), a graphics processing unit (GPU), or both), and various memory nodes 708. The host OS 704 may include a hypervisor 710 which is able to control the functions and/or communicate with a virtual machine (“VM”) 712 running on machine readable media. The VM 712 also may include a virtual CPU or vCPU 714. The memory nodes 708 may be linked or pinned to virtual memory nodes or vNodes 716. When the memory node 708 is linked or pinned to a corresponding vNode 716, then data may be mapped directly from the memory nodes 708 to the corresponding vNode 716.

All the various components shown in host machine 702 may be connected with and to each other, or communicate to each other via a bus (not shown) or via other coupling or communication channels or mechanisms. The host machine 702 may further include a video display, audio device or other peripherals 718 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 720 (also referred to as disk drive unit), and a network interface device 722. The host machine 702 may further include a data encryption module (not shown) to encrypt data. The components provided in the host machine 702 are those typically found in computer systems that may be suitable for use with aspects of the present disclosure and are intended to represent a broad category of such computer components that are known in the art. Thus, the system 700 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 724 also may be a Solid-state Drive (SSD), a hard disk drive (HDD) or other includes a computer or machine-readable medium on which is stored one or more sets of instructions and data structures (e.g., data/instructions 726) embodying or utilizing any one or more of the methodologies or functions described herein. The data/instructions 726 also may reside, completely or at least partially, within the main memory node 708 and/or within the processor(s) 706 during execution thereof by the host machine 702. The data/instructions 726 may further be transmitted or received over a network 728 via the network interface device 722 utilizing any one of several well-known transfer protocols (e.g., Hyper Text Transfer Protocol (HTTP)).

The processor(s) 706 and memory nodes 708 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 702 and that causes the host machine 702 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital, or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 702, with each server 730 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As previously discussed, it could be beneficial to use geospatial data to customize a user experience during a live event. However, it could be further beneficial to use geospatial data to customize a user experience based on the specific location of the user. For example, different geographic locations can have distinct cultures, atmospheres, or “vibes” due to a variety of factors, including geography, history, social makeup, and economic conditions. These influences can shape the physical environment, social norms, and daily life, creating a unique sense of place. Conventional music streaming and playlist services are designed primarily for individual users and fail to address the unique challenges of delivering context-aware, location-specific music experiences, for example, in association with specific places, such as cities, stores, and other venues. Existing platforms typically require operators to manually select and manage playlists or allow users to access large catalogs without regard to the location in which playback occurs. As a result, playlists are often poorly matched to the cultural and social context of a location, inconsistent with the preferences of local patrons, and disconnected from the physical environment in which they are consumed. Moreover, current solutions lack mechanisms for dynamically generating and evolving playlists based on collective user input and real-time contextual signals. Operators must opt-in and manually manage playlists, and users searching for content related to a location receive generic results rather than those tailored to that particular location. Traditional systems also fail to incorporate geolocation data into the playlist-generation process, resulting in playlists that are not geographically relevant. Furthermore, existing platforms do not provide a scalable way to aggregate user input to refine playlists over time while preserving a consistent “vibe” or character associated with a particular location. Accordingly, there is a need for devices, systems, and methods for customizing a user experience based on geospatial data.

Such devices, systems, and methods should autonomously generate, update, and manage playlists for public spaces based on geographic location, contextual data, and user participation, without requiring operators to actively manage content. There is also a need for such a system to enable real-time adaptation of playlists through collective user input, while maintaining a cohesive audio experience that reflects the cultural, social, and geographic character of the environment. The present disclosure provides devices, systems, and methods for autonomously generating, updating, and delivering curated playlists for locations and/or venues based on contextual information such as geographic location, venue identity, and aggregated user input. In contrast to conventional streaming services that require manual playlist selection or venue opt-in, the disclosed system automatically associates a user device with a location and/or venue based on location data or venue-specific identifiers such as machine-readable codes (e.g., QR codes), and then requests generation of a playlist tailored to that location.

For example, a location-specific media engine may integrate with a machine learning model, such as a large language model (“LLM”), to create a initial playlist comprising well-known songs, local favorites, and other selections determined to reflect the cultural or social character of the identified location. The playlist can be curated primarily by the system based on contextual data, while also enabling user participation—such as voting on tracks or contributing song selections—to influence playlist evolution over time. The devices, systems, and methods disclosed herein may further apply geographical constraints, such as limiting playlist access and/or modification to users in confirmed locations within a defined radius of a user's device, ensuring that playlist content is relevant to the user's immediate environment. Location-specific playlists may also be accessed through scanning a machine-readable code or other identifier presented at the location. Because the playlists are tied to a specific location identity, a user searching broadly (e.g., for “Miami vibe”) will not receive generic or irrelevant results, but rather a specific playlist curated for the precise location context, assuming their actual physical location has been confirmed by the system (e.g., via geospatial data or machine-readable code).

Additionally, the devices, systems, and methods disclosed herein may additionally provide a dynamic playlist updating mechanism in which new songs added by users within a defined time window are incorporated into an updated playlist, preserving the overall nature or “vibe” of the original playlist while adapting to evolving preferences. The devices, systems, and methods disclosed herein may also analyze playlist composition to detect and remove outlier songs that disrupt cohesion, thereby producing a more uniform listening experience. Over time, the playlist may continuously refine itself based on real-time input and contextual data signals, producing a music experience that is more closely aligned with the character of the location and preferences of its patrons than is possible with conventional systems. By combining geolocation data, AI-driven playlist generation, and collaborative user input, the devices, systems, and methods disclosed herein may transform the way music is delivered in public venues, enabling location-specific, context-aware playlists to be autonomously generated and evolved without requiring active management by operators.

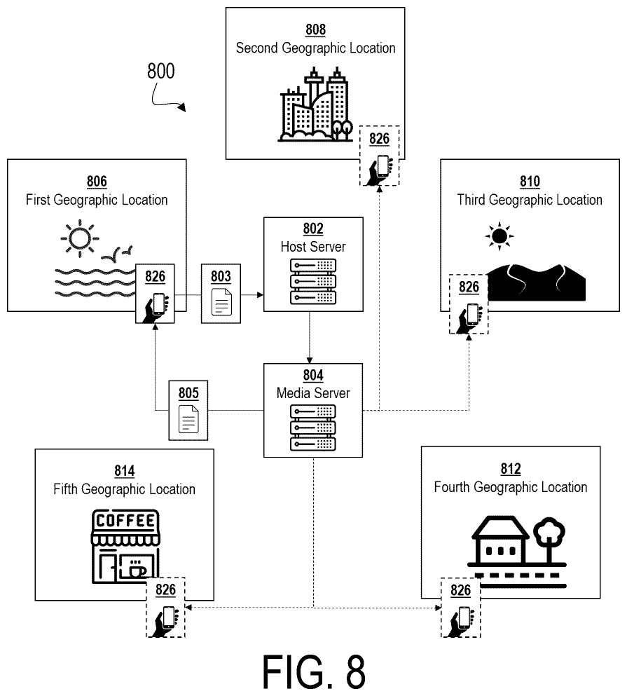

Referring now to FIG. 8, a block diagram of a system 800 configured to autonomously customize a user experience based on geospatial data is depicted according to at least one non-limiting aspect of the present disclosure. According to FIG. 8, the system 800 may include a host sub-system 802, a media sub-system 804, and one or more computing devices 826 configured to generate geospatial data 803 associated with one or more geographic locations 806, 808, 810, 812, 814. As depicted in FIG. 8, the host sub-system 802 can be configured to confirm a location of the computing device 826 based on the geospatial data 803 and broker communications to and from the media sub-system 804 based on the confirmation. In other words, based on the confirmation of a location of the computing device 826 based on the geospatial data 803, the host sub-system 802 can cause the media sub-system 804 to provide the computing device 826 with access to a media stream 805 associated with the geographic location 806, 808, 810, 812, 814 the computing device 826 is located within. It shall be appreciated that the components of the system 800 may be communicatively coupled via one or more wired or wireless networks, such as an infrastructure network (e.g., local area network (“LAN”), a wireless local area network (“WLAN”), a cellular network, a satellite network, etc.) and/or an ad hoc network (e.g., a Bluetooth® connection, near field communication (“NFC”), Zigbee®, etc.).

According to the non-limiting aspect of FIG. 8 the host sub-system 802 can include one or more network-accessible computing systems executing a software application configured to associate user devices with specific geographic locations and broker access to media experiences associated with those locations. According to some embodiments, the application may be accessed by the computing device 826 via a web portal, native application, or other network-connected interface. The host sub-system 802 may include one or more processors, memory devices, communication interfaces, and non-transitory computer-readable media storing instructions that, when executed, cause the host server to perform the various methods and operations described herein. The media sub-system 804 may also include one or more computing systems—such as the computer system 700 of FIG. 7—that includes a memory configured to store, generate, or manage access to a media stream 805, which may include digital media content such as a music playlist. According to some embodiments, the media sub-system 804 may be provided by a third-party media platform, such as a streaming service, and may host media and/or playlists that are generated or selected based on geographic context and other metadata supplied by the host sub-system 802.

The system 800 of FIG. 8 may further include one or more computing devices 826, such as a smartphone, a tablet, a laptop, a wearable device, and/or other network-enabled client devices. Each computing device 826 may include a processor, a memory, a display, a wireless transceiver, and one or more onboard sensors configured to determine a current geographic position of the device. Examples of such sensors can include global positioning system (“GPS”) receivers, cellular network radios, and Wi-Fi transceivers configured to derive geospatial coordinates. It shall be appreciated that, when a computing device 826 is located within or near a geographic region, such as a first geographic location 806, the device may generate geospatial data 803 corresponding to its position. The geospatial data 803 may be determined autonomously by the device using sensor-derived position data, or it may be obtained by scanning a machine-readable code (e.g., a QR code, data matrices, Aztec codes, PDF417, UPC, RFID tags, Code 128, JAB codes, NFC tags, etc.) presented at the location. In either case, the geospatial data 803 may be transmitted to the host sub-system 802 via a secure network connection.

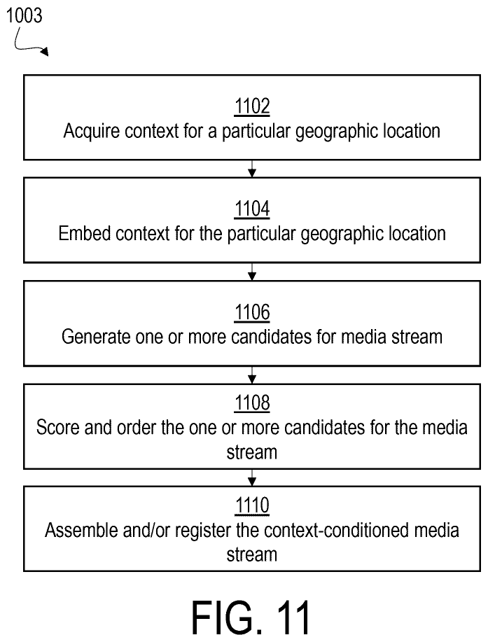

Still referring to FIG. 8, upon receiving the geospatial data 803, the host sub-system 802 may identify a geographic location associated with that data and determine one or more media experiences linked to that location. For example, the host sub-system 802 may query a database or apply a machine-learning model trained on historical user data, contextual metadata, and content profiles to select a media stream 805 associated with the first geographic location 806. The host sub-system 802 may then broker access between the computing device 826 and the media sub-system 804 to deliver the identified playlist to the user. According to some embodiments, the media stream 805 may be generated dynamically in response to the geospatial data 803 rather than being pre-associated with the location. For example, the host sub-system 802 may further include a location-specific media engine configured to generate, access, and/or modify the media stream 805 based on the geospatial data 803. According to some non-limiting aspects, if a location-specific media stream 805 does not currently exist, the location-specific media engine can include a machine learning model, such as an LLM, stored in a memory and configured to generate the location-specific media stream 805 when executed by a processor of the host sub-system 802. Initial generation of media stream 805 will be described in further detail herein with respect to FIG. 11. However, it shall be appreciated that the location-specific media engine may be trained on and/or retrieve song metadata, user behavior patterns, geolocation-specific trends, and/or data retrieved from a third-party source (e.g., a social media site, a location-specific website, etc.) to curate a media stream 805 consistent with the cultural or environmental characteristics of the first geographic location 806. The generated media stream 805 may then be streamed via the media sub-system 804 to the computing device 826 upon confirmation of the geospatial data 803 and receipt of instructions from the host sub-system 802.

According to some embodiments, the system 800 of FIG. 8 can customize a user experience based on geospatial data because the host sub-system 802 can be configured to retrieve contextual content data and/or metadata relevant to a geographic location 806, 808, 810, 812, 814. For example, in some aspects, the host sub-system 802 can deploy a web crawler, or an automated software program that systematically browses the internet to discover and collect information from web pages associated with the geographic location 806, 808, 810, 812, 814. This gathered data, which can include content, keywords, and links of pages associated with the geographic location 806, 808, 810, 812, 814, can be used by the host sub-system 802 to generate a context-conditioned media stream for the geographic location 806, 808, 810, 812, 814. According to other aspects, the host sub-system 802 can retrieve contextual content data in the form of a pre-existing media stream (e.g., a country music playlist) associated with the geographic location 806, 808, 810, 812, 814 (e.g., Waco, Texas). The host sub-system 802 can use this pre-existing media stream as a basis on which it generates a context-conditioned media stream for the geographic location 806, 808, 810, 812, 814, for example, by modifying the pre-existing media stream based on the inputs (e.g., votes, number of plays, likes, dislikes, etc.) received from a computing device 826 confirmed to be at the geographic location 806, 808, 810, 812, 814 based on geospatial data. According to still other aspects, the host sub-system 802 can employ a machine learning model, such as an LLM, to create a initial playlist comprising well-known songs, local favorites, and other selections determined to reflect the cultural or social character of the identified location. The host sub-system 802 can use this pre-existing media stream as a basis on which it generates a context-conditioned media stream for the geographic location 806, 808, 810, 812, 814, for example, by modifying the machine learning model generated initial playlist based on the inputs (e.g., votes, likes, dislikes, etc.) received from a computing device 826 confirmed to be at the geographic location 806, 808, 810, 812, 814 based on geospatial data. The pre-existing media stream and/or context-conditioned media stream for the geographic location 806, 808, 810, 812, 814 can be subsequently modified via user inputs (e.g., votes, number of plays, likes, dislikes, etc.) provided via a computing device 826 confirmed to be at the geographic location 806, 808, 810, 812, 814 based on geospatial data.

According to some aspects, the host sub-system 802 may enable additional functionality upon confirmation of the geospatial data 803. For example, the host sub-system 802 may enable a chat feature of an application accessible to the computing device (e.g., via a web portal or local application installed and executed) upon determining that the computing device 826 is in the geographic location 806 based on the geospatial data. For example, the chat feature may enable the computing device 826 to communicate with one or more additional computing devices that the host sub-system 802 has determined to be in the geographic location 806 based on geospatial data 803. According to some aspects, a user may not be required to participate in the chat feature or even see comments from other users displayed via the chat feature. For example, according to such aspects, the application accessible to the computing device may include a widget associated with the chat feature that, upon engagement, enables a user to communicate with other users confirmed to be at the same location based on geospatial data. However, if the user does not want to communicate with other users, they can choose not to engage with the widget.

According to other non-limiting aspects, the system 800 of FIG. 8 can be configured to use geospatial data 803 to enabled functionality that is implemented independent of a context-conditioned media stream for the geographic location 806, 808, 810, 812, 814. For example, a geographically specific chat feature that allows people to communicate only when they are physically within the same geographic location 806, 808, 810, 812, 814 could be useful independent of context-conditioned media stream. The system 800 can be configured to generate real-time geospatial data 803 from a combination of geolocation technologies such as GPS signals, Wi-Fi access point data, IP address lookups, or Bluetooth proximity to another computing device or the host sub-system 802. When a user engages the chat feature via a web portal or mobile application, the computing device 826 can share a location signature with the host sub-system 802. The host sub-system 802 can compare that data to pre-set geographic boundaries—called geofences—that define where the chat is active. If the user's verified position falls inside the allowed zone based on the real-time geospatial data 803, a chat window can open and messages from users within the same geographic location 806, 808, 810, 812, 814 can become visible. If the user moves outside that area, however, the system 800 can automatically limit or suspend participation until the location check again confirms presence inside the zone.

Such geospatial data 803 enabled features and functionality can be deployed on any website or mobile application, independent of a specific platform. For example, a web service could use the browser's geolocation API or a companion mobile app to collect latitude and longitude, then match those coordinates to stored regions such as campuses, parks, restaurants, bars or event venues. Once verified, the site's chat interface would display posts from others currently in the same zone, enabling local discussions in real time. The data exchange can happen securely through encrypted channels, and only minimal information (e.g., enough geospatial data 803 to confirm presence) can be stored. According to some non-limiting aspects, Bluetooth can also serve as a complementary or alternative technology, especially in indoor or short-range environments where GPS is unreliable. Small Bluetooth Low Energy (“BLE”) beacons can be placed around a geographic location 806, 808, 810, 812, 814 can continuously transmit unique identifiers. The computing device 826 can detect a specific beacon signal or set of signals with sufficient strength and the system 800 can infer that the user is within the corresponding geographic location 806, 808, 810, 812, 814 and can grant access to a chat tied to that space. Because Bluetooth signals can measure proximity to within a few meters, this can enable precise, room-level chat zones without depending on satellites or Wi-Fi triangulation. However, other aspects contemplate the use of other geospatial data 803, including GPS signals, Wi-Fi access point data, and/or IP address lookups, amongst others. Technologically, the system 800 may require an interface layer on the computing device 826 to collect and send geospatial data 803 and the host sub-system 802 can validate location against defined zones and include a chat engine that delivers messages only to authenticated users within those zones. Such embodiments can create an automatically enforced, location-specific communication network that can be embedded into any digital service where local interaction matters—such as community boards, events, or nearby meet-ups.

It shall be appreciated that the same principles may apply across multiple geographic locations, including a town, a city, a state, an airport, a retail location, a coffee shop, a restaurant, a bar, an arena, a stadium, a vehicle (e.g., an airplane, a train, a car, a cruise ship, etc.), a business location or office, a park, a school, and/or a university, amongst others. As shown in FIG. 8, additional locations such as a second geographic location 808, third geographic location 810, fourth geographic location 812, and fifth geographic location 814 may each have corresponding location-specific playlists accessible through the system 800, pending geospatial data 803 confirmation. Each computing device 826 that transmits geospatial data 803 to the host sub-system 802 may receive access to a media stream 805 uniquely associated with the identified location. For example, a user in a beach environment at the first geographic location 806 may receive a media stream 805 (e.g., a calypso playlist) reflecting that environment. A user in an urban center (e.g., Detroit) at the second geographic location 808 may receive a different media stream 805 (e.g., a Motown playlist) reflecting that environment. A user in a mountain environment at the third geographic location 810 may receive a different media stream 805 (e.g., a bluegrass playlist) reflecting that environment. A user in a small town environment at the fourth geographic location 812 may receive a different media stream 805 (e.g., an oldies playlist) reflecting that environment. A user in a coffee shop at the fifth geographic location 814 may receive a different media stream 805 (e.g., an indie folk playlist) reflecting that environment. Moreover, the system 800 can further enable a user to modify each location-specific media stream 805 upon confirmation of geospatial data 803, as will be described in further detail herein. However, it shall be appreciated that, absent confirmation of the geospatial data 803 by the host sub-system 802, a location-specific media stream 805 cannot be accessed of modified. This ensures that each location-specific media stream 805 can only be accessed and/or modified by users that have been confirmed by the host sub-system 802 to be physically present in that particular location 806, 808, 810, 812, 814, ensuring that the media streams 805 remain specifically tailored for and exclusively accessed via those geographic locations 806, 808, 810, 812, 814.

Accordingly, the aforementioned architecture enables the system 800 to solve specific technological problems that limit conventional media delivery systems. Specifically, the system 800 of FIG. 8 may provide a technical solution to the problem of static and non-contextual media delivery in conventional streaming services. Conventional devices, systems, and methods simply do not account for geospatial prior to allowing a user to access and modify a media stream 805 and, therefore, do not offer location-specific media streams 805. By autonomously deriving geospatial data from device hardware or by securely transmitting such data through machine-readable codes, the system 800 avoids the need for manual configuration by operators or users. Additionally, by brokering media stream 805 access based on real-time geospatial data 803 (e.g., location signals and contextual metadata), the host sub-system 802 improves the functionality of computer-implemented playlist delivery, enabling location-specific media experiences that evolve with user context. Further, the integration of machine-learning-driven playlist selection or generation improves the efficiency and scalability of media curation processes, producing playlists that dynamically reflect environmental and cultural factors without human intervention. By combining sensor-derived geospatial data, network-based venue association, and machine-learning-based content generation, the disclosed system enables computing devices to autonomously retrieve and deliver playlists that are contextually relevant to their physical environment, thereby enhancing both the operation of the computing systems involved and the resulting user experience.

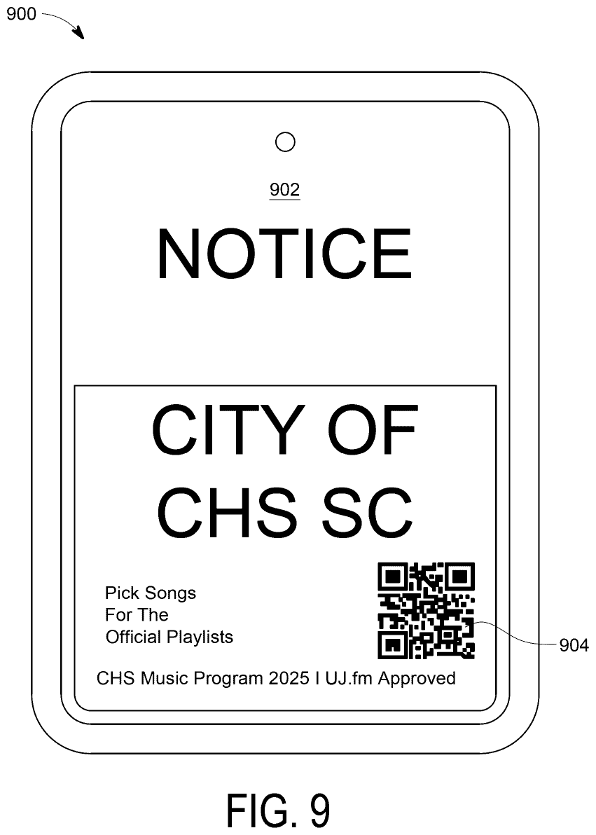

Referring now to FIG. 9, a notification 900 that includes a machine-readable code 904 configured for use with the system 800 of FIG. 8 is depicted according to at least one non-limiting aspect of the present disclosure. As depicted in FIG. 9, the notification 900 may further include a notice 902 along with the exemplary machine-readable code 904, each of which may be configured to enable a computing device 826 (FIG. 8) to transmit geospatial data 803 (FIG. 8) to the host sub-system 802 (FIG. 8) to initiate access to a playlist 805 (FIG. 8) associated with a particular geographic location such as the first geographic location 806 (FIG. 8). The notification 900, for example, can facilitate autonomous customization of a user experience based on geospatial data 803 (FIG. 8). The notice 902, for example, may be presented as part of a physical sign, digital display, or other visible medium located within a defined physical environment. According to some embodiments, the notice 902 may be positioned in a publicly accessible area of a building, venue, municipality, transit hub, or other geographic location and may include textual, graphical, or symbolic indicators prompting user interaction. The notice 902 may inform users that media streams 805 (FIG. 8) associated with the current geographic location are available and may instruct them to interact with the machine-readable code 904 to participate in playlist selection or playback.

Still referring to FIG. 9, the machine-readable code 904 may include any optical, signal emitting, or electronic code that can be scanned by a computing device 826 (FIG. 8), including but not limited to a QR code, barcode, or NFC tag. When scanned by a camera or sensor of the computing device 826 (FIG. 8), the machine-readable code 904 may encode data identifying the specific geographic location in which the notification 900 is displayed. The encoded data may include, for example, geospatial coordinates, venue identifiers, or URLs that resolve to an application endpoint hosted by the host sub-system 802 (FIG. 8). Upon scanning the machine-readable code 904, the computing device 826 (FIG. 8) may autonomously transmit the encoded geospatial data 803 (FIG. 8) to the host sub-system 802 (FIG. 8) via a network connection. The host sub-system 802 (FIG. 8) may then process the received geospatial data 803 (FIG. 8) to identify the associated geographic location (e.g., first geographic location 806 (FIG. 8)) and may broker access to a media stream 805 (FIG. 8) corresponding to that location on the media sub-system 804 (FIG. 8). As described above with respect to FIG. 8, the playlist 805 (FIG. 8) may include an initial set of songs generated by a machine learning model based on contextual metadata for the geographic location and may be refined over time based on aggregated user input.

According to some embodiments, the notification 900 of FIG. 9 may also provide additional interactive functionality beyond geospatial identification. For example, the machine-readable code 904 may link the user's computing device 826 (FIG. 8) directly to a playlist contribution interface hosted by the host sub-system 802 (FIG. 8), through which the user may submit song selections, vote on playlist content, or provide feedback data. Such user input may then be processed by the playlist generation engine described with respect to FIG. 8 to update and refine the playlist 805 (FIG. 8) associated with the location.

In further reference to FIG. 9, the use of notification 900 and machine-readable code 904 provides a technical mechanism for linking physical locations to digital services without requiring manual input of location identifiers or venue data by the user. By embedding geospatial identifiers directly into a scannable code, the system improves the efficiency and accuracy of associating computing devices 826 (FIG. 8) with specific geographic locations. This automated association in turn enables the host sub-system 802 (FIG. 8) to deliver location-specific playlists 805 (FIG. 8) dynamically, leveraging the same geospatial data 803 (FIG. 8) used to generate and refine playlists as described above.

Accordingly, FIG. 9 illustrates how physical infrastructure elements such as notification 900 and machine-readable code 904 can be integrated with the geospatial data-driven architecture of system 800 (FIG. 8) to enable seamless, location-aware media delivery and collaborative playlist curation. By bridging physical locations and network-connected computing systems through machine-readable encodings, the disclosed system enhances the functionality of media delivery platforms and provides a scalable, automated means of customizing user experiences based on real-world context.

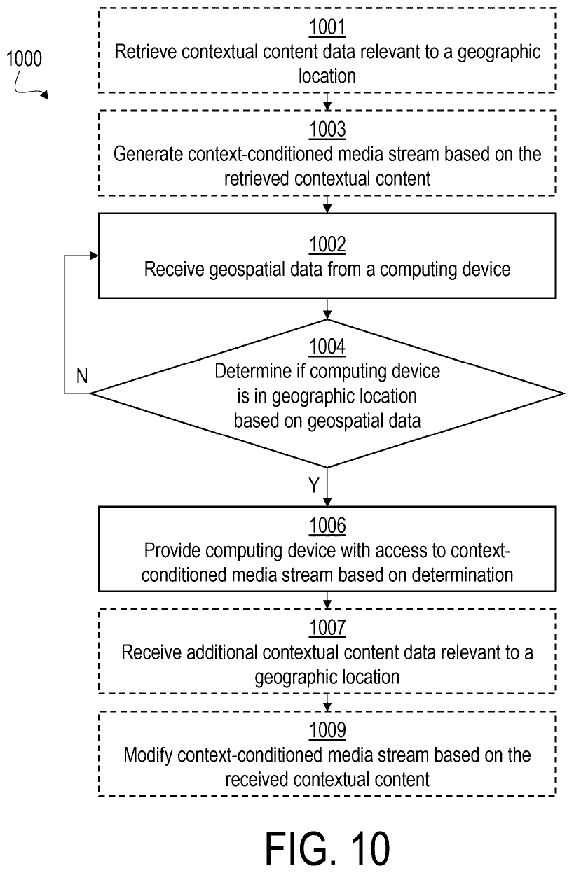

Referring now to FIG. 10, an algorithmic flow diagram of a method 1000 of autonomously customizing a user experience based on geospatial data is depicted according to at least one non-limiting aspect of the present disclosure. The method 1000 can be performed, in whole or in part, by the host sub-system 802 (FIG. 8) of the system 800 (FIG. 8) upon execution of the aforementioned location-specific media engine by at least one control circuit. Although described in a particular order, the steps of the method 1000 need not be performed in the precise sequence shown, and one or more steps may be performed in parallel, repeated, omitted, or reordered without departing from the scope of the present disclosure.

In further reference to FIG. 10, the method 1000 can include retrieving 1001 contextual content data relevant to a geographic location. For example, the contextual content data may include publicly available information from third-party sources such as social media feeds, the media sub-system 104, websites containing information about the geographic location, crowd-sourced review platforms associated with the geographic location, public databases containing information about the geographic location, or historical trend data associated with the geographic location. According to some non-limiting embodiments, the location-specific media engine can include a machine-learning model, such as an LLM configured to understand the cultural and environmental characteristics associated with the geographic location and retrieve the contextual content data. In some embodiments, retrieving 1001 the contextual content data can be performed autonomously by the host sub-system 802 (FIG. 8) in response to a new geographic location being registered in the system 800 (FIG. 8).

Still referring to FIG. 10, the method 1000 can optionally include generating 1003 a context-conditioned media stream based on the retrieved contextual content. In one embodiment, the host sub-system 802 (FIG. 8) may execute a machine-learning model, such as an LLM, to analyze the contextual content and generate an initial playlist or other media stream representative of the cultural, social, or environmental “vibe” of the geographic location. The media stream may include songs, audio programs, or other media assets selected according to features such as genre, tempo, lyrical content, artist origin, or historical popularity associated with the location. In other words, the retrieving 1001 and generating 1003 steps may together provide an automated bootstrapping process by which a location-specific media experience is initialized before user interaction occurs.

According to FIG. 10, the method 1000 can further include receiving 1002 geospatial data from a computing device 826 (FIG. 8). The geospatial data may be autonomously generated by sensors of the computing device 826 (FIG. 8), such as a global positioning system (GPS) receiver, cellular network transceiver, or Wi-Fi radio, or it may be received through user interaction with a machine-readable code (e.g., the machine-readable code 904 shown in FIG. 9) that encodes geospatial identifiers. The geospatial data may include latitude and longitude coordinates, a geofence identifier, or other metadata identifying a physical location. According to some non-limiting aspects, the aforementioned retrieving 1001 and generating 1003 steps may be initiated upon receiving 1002 the geospatial data from a computing device 826 (FIG. 8). For example, if a user sits down at a table in a first geographic location (e.g., a bar or restaurant), they may scan a QR code on the menu, which may initiate the aforementioned retrieval of contextual content—for example, from a social media page associated with the bar or restaurant—and generate a media stream based on the retrieved contextual content. For example, if a comments section of that page repeatedly references a particular genre (e.g., country) or artist (e.g., Brad Paisely), the media stream might be generated to include audio files associated with that genre and/or artist.

The method 1000 of FIG. 10 can further include determining 1004 whether the computing device 826 (FIG. 8) is within the geographic location based on the received geospatial data. The host sub-system 802 (FIG. 8) may compare the received geospatial data against known geographic boundaries or stored location profiles to resolve whether the computing device 826 is located within the region associated with the context-conditioned media stream. If it is determined that the computing device 826 (FIG. 8) is not within the geographic location, the host sub-system 802 (FIG. 8) may deny access or prompt the user to relocate. However, if it is determined that the computing device 826 (FIG. 8) is within the geographic location, the method 1000 may further include providing 1006 the computing device 826 (FIG. 8) with access to the context-conditioned media stream based on the determination. In other words, the host sub-system 802 (FIG. 8) may broker a connection between the computing device 826 (FIG. 8) and the media sub-system 804 (FIG. 8) to enable playback of the playlist or other media stream associated with the geographic location.

In order to refine and evolve the media experience over time, the method 1000 of FIG. 10 can further include receiving 1007 additional contextual content data relevant to the geographic location. The additional contextual content data may include user input collected from computing devices 826 (FIG. 8), such as song votes, playlist additions, skips, or other feedback signals (e.g., likes or dislikes). It may also include updated contextual information from external sources, such as social media data, event data, trending content, or seasonal metadata, thereby allowing the system to reflect temporal changes in the cultural environment. The method 1000 can then include modifying 1009 the context-conditioned media stream based on the received additional contextual content. The host sub-system 802 (FIG. 8) may apply machine-learning algorithms, clustering techniques, or other adaptive filtering methods to update the playlist or media stream by adding content that aligns with the evolving contextual profile or removing content that no longer reflects the location's vibe. Over time, repeated execution of the receiving 1007 and modifying 1009 can enable the media stream to converge toward an increasingly accurate representation of the cultural and social character of the geographic location, as expressed by both contextual data and real-time user engagement. Accordingly, the method 1000 of FIG. 10 can provide a technical solution to the problem of delivering static, non-contextual media streams in conventional systems. By autonomously retrieving contextual content, generating media streams conditioned on that content, associating computing devices with specific geographic locations using geospatial data, and adaptively modifying those media streams based on ongoing contextual inputs, the disclosed system enhances the operation of networked computing environments to deliver location-aware, continuously evolving media experiences without requiring manual playlist management.

Referring now to FIG. 11, an algorithmic flow diagram of a method 1003 of generating and modifying a location-specific media stream is depicted according to at least one non-limiting aspect of the present disclosure. Once again, the method 1003 can be performed, in whole or in part, by the host server 802 of the system 800 (see FIG. 8) when a location-specific media engine stored in memory is executed by one or more control circuits. Although described as a sequence of steps, one or more of the steps may be performed in parallel, repeated, omitted, or reordered without departing from the scope of the present disclosure.

According to FIG. 11, the method 1003 can include acquiring 1102 contextual data for a particular geographic location. For example, the contextual data can include structured or unstructured information describing attributes of the location, such as venue type, historical events, seasonal patterns, demographic trends, cultural markers, and local preferences. As previously discussed, the contextual data can be retrieved from a variety of third-party and internal sources, including public event calendars, records, social media feeds, crowd-sourced review platforms, music-chart databases, and historical playback data. In some embodiments, the contextual data may further include machine-learned representations derived from prior playlist performance or user engagement in the same or similar geographic locations. The method 1003 can further include embedding 1104 the contextual data for the particular geographic location. For example, the host sub-system 802 (FIG. 8) may process the retrieved contextual data into one or more structured feature representations suitable for use by a machine learning model, such as an LLM or other generative model. This embedding process may include extracting relevant features (e.g., genre distribution, tempo profiles, energy levels, lyrical sentiment, artist origin, and recency) and encoding those features into numerical vectors representing the cultural and social “vibe” of the geographic location. The embedding may also include generating a textual or semantic summary of unstructured data that captures high-level patterns or trends relevant to playlist construction.

Still referring to FIG. 11, the method 1003 can further include generating 1106 a set of candidate media items for the media stream. Using the embedded contextual representations as inputs, the LLM or another recommendation engine can identify a candidate pool of songs or media content from one or more content catalogs. Selection of candidate items can be conditioned on similarity between the contextual embedding and metadata associated with available media, including but not limited to genre, energy, tempo, historical popularity, artist origin, and prior performance in similar environments. In some embodiments, filtering criteria such as licensing restrictions, duration constraints, or explicit-content filters may also be applied during this stage. The method 1003 can additionally include scoring and ordering 1108 the candidate media items. Each candidate may be assigned a composite relevance score based on multiple weighted factors, including similarity to the contextual embedding, cultural or geographic relevance, popularity, freshness, and contribution to playlist diversity. The scoring process may further incorporate machine-learning-based ranking algorithms or reinforcement signals derived from historical user engagement data. Based on these scores, the host sub-system 802 (FIG. 8) may order the candidate media items to optimize playlist flow, ensuring smooth transitions in energy, tempo, or style that match the inferred characteristics of the location.

Finally, the method 1003 of FIG. 11 can include assembling and registering 1110 the media stream. In this step, the highest-scoring media items are compiled into a location-specific playlist or media stream, which may then be persisted in association with the geographic location and registered on a media sub-system 804 (FIG. 8). The assembled media stream may include metadata such as playlist provenance, contextual weights, scoring parameters, and model identifiers, enabling future iterations of the playlist to incorporate additional contextual content or user feedback. The registered playlist may be accessed by computing devices 826 upon transmission of geospatial data 803 or interaction with a machine-readable code 904 as described with respect to FIG. 9. Accordingly, it shall be appreciated that the method 1003 can enable the automated generation of a context-conditioned media stream that reflects the cultural and environmental characteristics of a specific geographic location. By leveraging large-scale contextual data, embedding representations, candidate generation, and machine-learning-based scoring, the disclosed approach improves the operation of networked computing systems and enables location-aware media experiences that adapt dynamically to their environment.

According to some non-limiting aspects, the present disclosure contemplates a computer-implemented method of customizing a user experience based on geospatial data, the method can include retrieving, via a host sub-system, contextual content data relevant to a geographic location, generating, via the host sub-system, a context-conditioned media stream based on the retrieved contextual content, receiving, via the host sub-system, geospatial data from a computing device, determining, via the host sub-system, that the computing device is in the geographic location based on the geospatial data, and providing, via the host sub-system, the computing device with access to the context-conditioned media stream based on determination that the computing device is in the geographic location based on the geospatial data.

According to some non-limiting aspects, the method includes receiving, via the host sub-system, additional contextual content data relevant to a geographic location, and modifying, via the host sub-system, the context-conditioned media stream based on the received additional contextual content.

According to some non-limiting aspects, the geospatial data is generated by a sensor of the computing device.

According to some non-limiting aspects, the geospatial data is received in response to the computing device reading a machine-readable code positioned in the geographic location.

According to some non-limiting aspects, the machine-readable code includes a quick response code, a data matric, an Aztec codes, a near-field communication signal, or a radio frequency identification signal.

According to some non-limiting aspects, generating the context-conditioned media stream based on the retrieved contextual content includes acquiring, via the host sub-system, context for a particular geographic location, embedding, via the host sub-system, the context for the particular geographic location, generating, via the host sub-system, one or more candidate media items for the context-conditioned media stream based on the embedded context, scoring, via the host sub-system, the one or more candidate media items for the context-conditioned media stream based on the embedded context, and generating, via the host sub-system, the context-conditioned media stream based on the scores for the one or more candidate media items.

According to some non-limiting aspects, embedding the context for the particular geographic location includes processing, via the host sub-system, the contextual content data into one or more structured feature representations.

According to some non-limiting aspects, processing the contextual content data into one or more structured feature representations includes extracting, via the host sub-system, a relevant feature and encoding the relevant feature into a numerical vector associated with the geographic location.

According to some non-limiting aspects, the relevant feature includes a genre distribution, a tempo profile, an energy level, a lyrical sentiment, an artist origin, or recency, or combinations thereof.

According to some non-limiting aspects, generating the one or more candidate media items for the context-conditioned media stream includes identifying, via the host sub-system, a candidate pool of media items based on the numerical vector associated with the geographic location.

According to some non-limiting aspects, generating the one or more candidate media items for the context-conditioned media stream further includes filtering, via the host sub-system, the candidate pool of media items based on a user preference.

According to some non-limiting aspects, the user preference includes a licensing restriction, a duration constraint, or an explicit-content filter.

According to some non-limiting aspects, scoring the one or more candidate media items for the context-conditioned media stream is based on a cultural relevance, a geographic relevance, a popularity, or a freshness, or combinations thereof.

According to some non-limiting aspects, the method further includes registering, via the host sub-system, the context-conditioned media stream with a media sub-system, such that the computing device can access the context-conditioned media stream via the media sub-system.

According to some non-limiting aspects, the method further includes enabling, via the host sub-system, a chat feature of an application accessed via the computing device based on determination that the computing device is in the geographic location based on the geospatial data, wherein the chat feature enables the computing device to communicate with another computing device determined, via the host sub-system, to be in the geographic location based on geospatial data.

According to some non-limiting aspects, the present disclosure contemplates a system for customizing a user experience based on geospatial data. The system can include a control circuit and a memory configured to store a location-specific media engine that, when executed by the control circuit, causes the system to retrieve contextual content data relevant to a geographic location, generate a context-conditioned media stream based on the retrieved contextual content, receive geospatial data from a computing device, determine that the computing device is in the geographic location based on the geospatial data, and provide the computing device with access to the context-conditioned media stream based on determination that the computing device is in the geographic location based on the geospatial data.

According to some non-limiting aspects, when executed by the control circuit, the location-specific media engine further causes the system to receive additional contextual content data relevant to a geographic location, and modify the context-conditioned media stream based on the received additional contextual content.

According to some non-limiting aspects, to generate the context-conditioned media stream based on the retrieved contextual content, when executed by the control circuit, the location-specific media engine, the location-specific media engine causes the system to embed the context for the geographic location, generate one or more candidate media items for the context-conditioned media stream based on the embedded context, score the one or more candidate media items for the context-conditioned media stream based on the embedded context; and generate the context-conditioned media stream based on the scores for the one or more candidate media items.

According to some non-limiting aspects, when executed by the control circuit, the location-specific media engine further causes the system to enable a chat feature of an application accessed via the computing device based on determination that the computing device is in the geographic location based on the geospatial data, wherein the chat feature enables the computing device to communicate with another computing device determined, via the host sub-system, to be in the geographic location based on geospatial data.

According to some non-limiting aspects, the present disclosure contemplates a method of customizing a user experience based on geospatial data, the method including acquiring, via a host sub-system, context for a particular geographic location; embedding, via the host sub-system, the context for the particular geographic location; generating, via the host sub-system, one or more candidate media items for a context-conditioned media stream based on the embedded context; scoring, via the host sub-system, the one or more candidate media items for the context-conditioned media stream based on the embedded context; and generating, via the host sub-system, the context-conditioned media stream based on the scores for the one or more candidate media items.

All patents, patent applications, publications, or other disclosure material mentioned herein, are hereby incorporated by reference in their entirety as if each individual reference was expressly incorporated by reference, respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”and “one or more”to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B. ”

With respect to the appended claims, those skilled in the art will appreciate that recited operations therein may generally be performed in any order. Also, although claim recitations are presented in a sequence(s), it should be understood that the various operations may be performed in other orders than those which are described or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a,” “an,” and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 150%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100.

Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random-access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microcontroller configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instructions sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,”“operable/operative to,”“adapted/adaptable,”“able to,”“conformable/conformed to,”etc.

Those skilled in the art will recognize that “configured to” can generally encompass active-state components and/or inactive-state components and/or standby-state components unless context requires otherwise.

What is claimed is:

1. A computer-implemented method of customizing a user experience based on geospatial data, the method comprising:
retrieving, via a host sub-system, contextual content data relevant to a geographic location;
generating, via the host sub-system, a context-conditioned media stream based on the retrieved contextual content;
receiving, via the host sub-system, geospatial data from a computing device;
determining, via the host sub-system, that the computing device is in the geographic location based on the geospatial data; and
providing, via the host sub-system, the computing device with access to the context-conditioned media stream based on determination that the computing device is in the geographic location based on the geospatial data.

2. The method of claim 1, further comprising:
receiving, via the host sub-system, additional contextual content data relevant to a geographic location; and
modifying, via the host sub-system, the context-conditioned media stream based on the received additional contextual content.

3. The method of claim 1, wherein the geospatial data is generated by a sensor of the computing device.

4. The method of claim 1, wherein the geospatial data is received in response to the computing device reading a machine-readable code positioned in the geographic location.

5. The method of claim 4, wherein the machine-readable code comprises a quick response code, a data matric, an Aztec codes, a near-field communication signal, or a radio frequency identification signal.

6. The method of claim 1, wherein generating the context-conditioned media stream based on the retrieved contextual content comprises:
acquiring, via the host sub-system, context for a particular geographic location;
embedding, via the host sub-system, the context for the particular geographic location;
generating, via the host sub-system, one or more candidate media items for the context-conditioned media stream based on the embedded context;
scoring, via the host sub-system, the one or more candidate media items for the context-conditioned media stream based on the embedded context; and
generating, via the host sub-system, the context-conditioned media stream based on the scores for the one or more candidate media items.

7. The method of claim 6, wherein embedding the context for the particular geographic location comprises:
processing, via the host sub-system, the contextual content data into one or more structured feature representations.

8. The method of claim 7, wherein processing the contextual content data into one or more structured feature representations comprises:
extracting, via the host sub-system, a relevant feature and encoding the relevant feature into a numerical vector associated with the geographic location.

9. The method of claim 8, wherein the relevant feature comprises a genre distribution, a tempo profile, an energy level, a lyrical sentiment, an artist origin, or recency, or combinations thereof.

10. The method of claim 8, wherein generating the one or more candidate media items for the context-conditioned media stream comprises:
identifying, via the host sub-system, a candidate pool of media items based on the numerical vector associated with the geographic location.

11. The method of claim 10, wherein generating the one or more candidate media items for the context-conditioned media stream further comprises:
filtering, via the host sub-system, the candidate pool of media items based on a user preference.

12. The method of claim 11, wherein the user preference comprises a licensing restriction, a duration constraint, or an explicit-content filter.

13. The method of claim 6, wherein scoring the one or more candidate media items for the context-conditioned media stream is based on a cultural relevance, a geographic relevance, a popularity, or a freshness, or combinations thereof.

14. The method of claim 6, further comprising:
registering, via the host sub-system, the context-conditioned media stream with a media sub-system, such that the computing device can access the context-conditioned media stream via the media sub-system.

15. The method of claim 1, further comprising:
selectively enabling, via the host sub-system, a chat feature of an application accessed via the computing device based on determination that the computing device is in the geographic location based on the geospatial data, wherein the chat feature enables the computing device to communicate with another computing device determined, via the host sub-system, to be in the geographic location based on geospatial data.

16. A system for customizing a user experience based on geospatial data, the system comprising:
a control circuit; and
a memory configured to store a location-specific media engine that, when executed by the control circuit, causes the system to:
retrieve contextual content data relevant to a geographic location;
generate a context-conditioned media stream based on the retrieved contextual content;
receive geospatial data from a computing device;
determine that the computing device is in the geographic location based on the geospatial data; and
provide the computing device with access to the context-conditioned media stream based on determination that the computing device is in the geographic location based on the geospatial data.

17. The system of claim 16, wherein, when executed by the control circuit, the location-specific media engine further causes the system to:
receive additional contextual content data relevant to a geographic location; and
modify the context-conditioned media stream based on the received additional contextual content.

18. The system of claim 16, wherein, to generate the context-conditioned media stream based on the retrieved contextual content, when executed by the control circuit, the location-specific media engine, the location-specific media engine causes the system to:
embed the context for the geographic location;
generate one or more candidate media items for the context-conditioned media stream based on the embedded context;
score the one or more candidate media items for the context-conditioned media stream based on the embedded context; and
generate the context-conditioned media stream based on the scores for the one or more candidate media items.

19. The system of claim 16, wherein, when executed by the control circuit, the location-specific media engine further causes the system to:
enable a chat feature of an application accessed via the computing device based on determination that the computing device is in the geographic location based on the geospatial data, wherein the chat feature enables the computing device to communicate with another computing device determined, via the host sub-system, to be in the geographic location based on geospatial data.

20. A method of customizing a user experience based on geospatial data, the method comprising:
acquiring, via a host sub-system, context for a particular geographic location;
embedding, via the host sub-system, the context for the particular geographic location;
generating, via the host sub-system, one or more candidate media items for a context-conditioned media stream based on the embedded context;
scoring, via the host sub-system, the one or more candidate media items for the context-conditioned media stream based on the embedded context; and
generating, via the host sub-system, the context-conditioned media stream based on the scores for the one or more candidate media items.
